(19) United States
(12) Patent Application Publication
(10) Pub. No.: US 2017/0261137 A1
(43) Pub. Date: Sep. 14, 2017

(54) COMPONENT RETAINING STRUCTURE FOR CONDUIT FITTING

(71) Applicant: Swagelok Company, Solon, OH (US)

(72) Inventors: Peter C. Williams, Cleveland Heights, OH (US); Cal R. Brown, Lyndhurst, OH (US); Douglas J. McClure, Mentor, OH (US); Gregory S. Kalata, Avon, OH (US); Ronald P. Campbell, Shaker Heights, OH (US); Douglas S. Welch, Chesterland, OH (US); Stephen J. Zaborszki, Northfield Center, OH (US); James E. Gotch, Kirtland, OH (US); Jordan J. Welle, Beachwood, OH (US); Elizabeth Mueller, Cleveland Heights, OH (US); Gregory R. Arcangelini, North Royalton, OH (US); Michael J. Mohlenkamp, Hudson, OH (US); Justin Hamilton, Lakewood, OH (US); William J. Knaggs, Medina, OH (US); Daniel G. Trivett, Mentor, OH (US); William H. Glime, III, Chagrin Falls, OH (US); Timothy Garrett Gray, Painesville, OH (US); Connor M. Dorony, Lakewood, OH (US); Donald E. NegreIii, Gates Mills, OH (US); Dale C. Arstein, Highland Heights, OH (US); Mark A. Clason, Orwell, OH (US); Keith M. Dando, Avon Lake, OH (US); Richard J. Mlinarik, Mantua, OH (US); Del C. Stamm, Mantua, OH (US); Ross A. Clark, Hudson, OH (US); Gary Matson, Cuyahoga falls, OH (US)

(21) Appl. No.: 15/441,694

(22) Filed: Feb. 24, 2017

Related U.S. Application Data
(60) Provisional application No. 62/305,071, filed on Mar. 8, 2016.
(60) Provisional application No. 62/437,149, filed on Dec. 21, 2016.

(51) Int. Cl. F16L 19/06; F16L 19/10

(52) U.S. Cl. CPC F16L 19/06; F16L 19/103

(57) ABSTRACT

A preassembly for a conduit fitting includes an annular fitting component having an interior wall extending along a central axis from an inboard end to an outboard end, a conduit gripping device disposed in the annular fitting component and comprising an outer radial surface at a back portion thereof, and a retaining device having an inboard first interlock portion that interlocks with the outer radial surface of the conduit gripping device, and an outboard second interlock portion axially spaced apart from the first interlock portion, the second interlock portion interlocking with the interior wall of the annular fitting component, such that the retaining device holds said annular fitting component and said conduit gripping device together as a discrete subassembly.

### CROSS-REFERENCE TO RELATED APPLICATIONS

This application claims priority to and all benefit of U.S. Provisional Patent Application Ser. No. 62/305,071, filed on Mar. 8, 2016, for COMPONENT RETAINING STRUCTURE FOR CONDUIT FITTING, and U.S. Provisional Patent Application Ser. No. 62/437,149, filed on Dec. 21, 2016, for COMPONENT RETAINING STRUCTURE FOR CONDUIT FITTING, the entire disclosures of both of which are fully incorporated herein by reference.

### TECHNICAL FIELD OF THE INVENTION

The present disclosure relates to fittings for making mechanically attached connections between a conduit and another fluid component, for containing liquid or gas fluids. More particularly, the disclosure relates to fittings for tube and pipe conduits that use one or more conduit gripping devices, such as for example, one or more ferrules.

### SUMMARY OF THE DISCLOSURE

In accordance with an embodiment of one or more of the inventions presented in this disclosure, a fitting assembly for conduits includes first and second fitting components, at least one conduit gripping device, and a retaining member assembled with the first fitting component to retain the at least one conduit gripping device with the first fitting component as a subassembly prior to the first and second fitting components being assembled together. When the first fitting component is assembled with the second fitting component, the second fitting component engages the retaining member to axially move the retaining member into axial alignment with a recessed portion of an interior wall of the first fitting component, thereby allowing the retaining member to be received in the recessed portion and radially separate from a frustoconical outer radial portion of the at least one conduit gripping device, to permit disassembly of the first fitting component from the at least one conduit gripping device. Prior to the first and second fitting components being assembled together, the outer radial portion of the at least one conduit gripping device blocks axial movement of the retaining member into axial alignment with the recessed portion of the interior wall.

In accordance with an embodiment of one or more of the inventions presented in this disclosure, a fitting assembly for conduits includes a first fitting component, a second fitting component that assembles with the first fitting component, at least one conduit gripping device, and a retaining member assembled with the first fitting component and seated in a first circumferential recess in the first fitting component to engage an outer radial portion of the at least one conduit gripping device, to retain the at least one conduit gripping device with the first fitting component as a subassembly prior to the first and second fitting components being assembled together. When the first fitting component is assembled with the second fitting component, the second fitting component engages the retaining member to axially move the retaining member into axial alignment with a second circumferential recess in the first fitting component, the second circumferential recess extending radially outward of the first circumferential recess, thereby allowing the retaining member to be received in the second circumferential recess and radially separate from an outer radial portion of the at least one conduit gripping device, to permit disassembly of the first fitting component from the at least one conduit gripping device. The first circumferential recess is separated from the second circumferential recess by a wall portion extending radially inward from the first and second circumferential recesses, with one of an inboard surface of the wall portion and an outboard surface of the retaining member being ramped, such that axial movement of the retaining member against the wall portion causes the retaining member to radially compress to allow the retaining member to move axially outward of the wall portion and into the second recess.

In accordance with another embodiment of one or more of the inventions presented in this disclosure, a preassembly for a conduit fitting includes an annular fitting component having an interior wall extending along a central axis from an inboard end to an outboard end, a projection connected to and extending radially inward from the interior wall, and at least a first conduit gripping device retained within the annular fitting component and including an outer radial portion defining a circumferential recess receiving the projection between radially extending inboard and outboard ends of the outer radial portion, for axial retention of the first conduit gripping device in the annular fitting component. When an axial outward force is applied to the first conduit gripping device, engagement of the projection with the inboard end of the outer radial portion causes the projection to bend out of engagement with the circumferential recess, permitting removal of the first conduit gripping device from the annular fitting component.

In accordance with another embodiment of one or more of the inventions presented in this disclosure, a fitting assembly for conduits includes a first fitting component having an interior wall extending along a central axis from an inboard end to an outboard end, a second fitting component that assembles with the first fitting component, an annular retaining member received in a circumferential recess in the interior wall of the annular fitting component, at least one conduit gripping device, and a retaining member received in a circumferential recess in the interior wall of the annular fitting component, the retaining member retaining the at least one conduit gripping device with the first fitting component as a subassembly prior to the first and second fitting components being assembled together. When the first fitting component is assembled with the second fitting component, the second fitting component engages the retaining member to radially expand the retaining member further into the circumferential recess, such that the retaining member radially separates from an outer radial portion of the at least one conduit gripping device, to permit disassembly of the first fitting component from the at least one conduit gripping device.

In accordance with another embodiment of one or more of the inventions presented in this disclosure, a fitting assembly for conduits includes a first fitting component having an interior wall extending along a central axis from an inboard end to an outboard end, a second fitting component that assembles with the first fitting component, at least a first conduit gripping device disposed in the first fitting component and including a first, inboard circumferential recess and a second, outboard circumferential recess radially inward of the first circumferential recess, and an annular retaining member seated between the first circumferential recess of the first conduit gripping device and a circumferential recess in the first fitting component. When the first fitting component is pulled up on the second fitting component, the second fitting component engages the retaining member to axially move the retaining member from the first circumferential recess to the second circumferential recess, wherein the annular retaining member radially contracts to radially separate from the circumferential recess of the first fitting component, to permit disassembly of the first fitting component from the first conduit gripping device.

In accordance with another embodiment of one or more of the inventions presented in this disclosure, a fitting assembly for conduits includes a first fitting component having an interior wall extending along a central axis from an inboard end to an outboard end, a second fitting component that assembles with the first fitting component, a first conduit gripping device disposed in the first fitting component, a second conduit gripping device disposed in the first fitting component between the first conduit gripping device and an annular shoulder portion of the first fitting component, the second conduit gripping device being releasably cartridged with the first conduit gripping device, and an annular retaining member having an outer radial portion received in a circumferential recess in the interior wall of the first fitting component and an inner radial portion extending radially inward between the first conduit gripping device and the second conduit gripping device to retain the second conduit gripping device with the first fitting component, When the first fitting component is pulled up on the second fitting component, the second fitting component engages the annular retaining member to plastically bend the retaining member to a release position radially outward of the second conduit pipping device, to permit disassembly of the first fitting component from the second conduit gripping device.

In accordance with another embodiment of one or more of the inventions presented in this disclosure, a fitting assembly for conduits includes a first fitting component having an interior wall extending along a central axis from an inboard end to an outboard end, a second fitting component that assembles with the first fitting component, a first conduit gripping device disposed in the first fitting component, a second conduit gripping device disposed in the first fitting component between the first conduit gripping device and an annular shoulder portion of the first fitting component, the second conduit gripping device being releasably cartridged with the first conduit gripping device, and a retaining projection connected with an interior surface of the first fitting component and including an inner radial portion engaging an outer radial surface of the second conduit gripping device to retain the second conduit gripping device with the first fitting component. When the first fitting component is pulled up on the second fitting component, radial expansion of the outer radial surface of the second conduit gripping device bends the inner radial portion of the retaining projection radially outward to permit disassembly of the first fitting component from the second conduit gripping device.

In accordance with another embodiment of one or more of the inventions presented in this disclosure, a fitting assembly for conduits includes a first fitting component having an interior wall extending along a central axis from an inboard end to an outboard end, a second fitting component that assembles with the first fitting component, a first conduit gripping device disposed in the first fitting component, a second conduit gripping device disposed in the first fitting component between the first conduit gripping device and an annular shoulder portion of the first fitting component, the second conduit gripping device being releasably cartridged with the first conduit gripping device, and a retaining member having a first end hook portion engaging an interior notch portion of the second conduit gripping device and a second end hook portion engaging an interior recess in an outboard end portion of the first fitting component to retain the second conduit gripping device with the first fitting component. When the first fitting component is pulled up on the second fitting component, radial expansion of a rear portion of the second conduit gripping device causes the interior notch portion of the second conduit gripping device to disengage from the first end hook portion to permit disassembly of the first fitting component from the second conduit gripping device.

In accordance with another embodiment of one or more of the inventions presented in this disclosure, a fitting assembly for conduits includes a first fitting component having an interior wall extending along a central axis from an inboard end to an outboard end, a second fitting component that assembles with the first fitting component, a first conduit gripping device disposed in the first fitting component, and a second conduit gripping device disposed in the first fitting component between the first conduit gripping device and an annular shoulder portion of the first fitting component, the second conduit gripping device being releasably cartridged with the first conduit gripping device. The second conduit gripping device includes a rear retaining extension having a hook portion engaging an interior recess in an outboard end portion of the first fitting component to retain the second conduit gripping device with the first fitting component. When the first fitting component is pulled up on the second fitting component, radial expansion of a rear portion of the second conduit gripping device causes the rear retaining extension to disengage from the interior recess in the outboard end portion of the first fitting component to permit disassembly of the first fitting component from the second conduit gripping device.

In accordance with another embodiment of one or more of the inventions presented in this disclosure, a preassembly for a conduit fitting includes an annular fitting component having an interior wall extending along a central axis from an inboard end to an outboard end, a first conduit gripping device disposed in the first fitting component, a second conduit gripping device disposed in the first fitting component between the first conduit gripping device and an annular shoulder portion of the first fitting component, the second conduit gripping device being releasably cartridged with the first conduit gripping device, and a cover member having a first end hook portion engaging an interior notch portion of the second conduit gripping device to retain the second conduit gripping device with the first fitting component, and a second end portion abutting an outboard end portion of the annular fitting component to cover a bore in the outboard end portion of the annular fitting component, the cover member being removable prior to installation of a conduit in the annular fitting component.

In accordance with another embodiment of one or more of the inventions presented in this disclosure, a preassembly for a conduit fitting includes an annular fitting component having an interior wall extending along a central axis from an inboard end to an outboard end, at least a first conduit gripping device disposed within the annular fitting component and including an outer radial portion, and a releasable material adhered between the interior wall of the annular fitting component and the outer radial portion of the first conduit gripping device for axial retention of the first conduit gripping device in the annular fitting component. When the annular fitting component is assembled with a mating fitting component and pulled up on a conduit, the releasable material separates to permit separation of the annular fitting component from the first conduit gripping device.

In accordance with another embodiment of one or more of the inventions presented in this disclosure, a method of assembling a preassembly for a conduit fitting includes the steps of providing an annular fitting component having an interior wall extending along a central axis from an inboard end to an outboard end, inserting at least a first conduit gripping device into the inboard end of the annular fitting component, and inserting a retaining member into the inboard end of the annular fitting component, such that an outer radial portion of the retaining member interlocks with a circumferential recess in the annular fitting component, and a radially inward extending projection is radially aligned with an outer radial portion of the first conduit gripping device to prevent withdrawal of the first conduit gripping device from the inboard end of the annular fitting component.

In accordance with another embodiment of one or more of the inventions presented in this disclosure, a preassembly for a conduit fitting includes a first conduit gripping device comprising a rear portion defining a first outer radial surface, a second conduit gripping device comprising a front portion defining a second outer radial surface, and a retaining device having a first interlock portion that interlocks with the first outer radial surface, and a second interlock portion that interlocks with the second outer radial surface, such that the retaining device holds the first conduit gripping device and the second conduit gripping device together as a discrete subassembly.

In accordance with another embodiment of one or more of the inventions presented in this disclosure, a preassembly for a conduit fitting includes an annular fitting component having an interior wall extending along a central axis from an inboard end to an outboard end, a conduit gripping device disposed in the annular fitting component and comprising an outer radial surface at a back portion thereof, and a retaining device having an inboard first interlock portion that interlocks with the outer radial surface of the conduit gripping device, and an outboard second interlock portion axially spaced apart from the first interlock portion. The second interlock portion interlocks with the interior wall of the annular fitting component, such that the retaining device holds the annular fitting component and the conduit gripping device together as a discrete subassembly.

In accordance with another embodiment of one or more of the inventions presented in this disclosure, a preassembly for a conduit fitting includes an annular fitting component having an interior wall extending along, a central axis from an inboard end to an outboard end, a first conduit gripping device disposed in the annular fitting component, a second conduit gripping device disposed in the annular fitting component between the first conduit gripping device and a drive surface of the annular fitting component, and a retaining device having a first interlock portion that interlocks with the first conduit gripping device and a second interlock portion that interlocks with the annular fitting component, such that the retaining device holds the first conduit gripping device, the second conduit gripping device, and the annular fitting component together as a discrete subassembly.

In accordance with another embodiment of one or more of the inventions presented in this disclosure, a preassembly for a conduit fitting includes a first conduit gripping device having a rear portion defining a first outer radial surface, a second conduit gripping device having a front portion defining a second outer radial surface, an annular fitting component having an interior wall extending along a central axis from an inboard end to an outboard end, and a retaining device having a first interlock portion that interlocks with the first conduit gripping device, and a second interlock portion that interlocks with the second conduit gripping device, such that the retaining device holds said first conduit gripping device and said second conduit gripping device together as a discrete subassembly prior to installation of the first and second conduit gripping device into the annular fitting component. The retaining device further includes a third interlock portion that interlocks with the interior wall of the annular fitting component when the first conduit gripping device, the second conduit gripping device, and the retaining device are installed in the annular fitting component.

In accordance with another embodiment of one or more of the inventions presented in this disclosure, a method of pre-installing a conduit gripping device in an annular fitting component includes the steps of providing an annular fitting component having an interior wall extending along a central axis from an inboard end to an outboard end, providing a preassembly including a conduit gripping device and a retaining device having an inboard first interlock portion that interlocks with an outer radial surface on an outboard portion of the conduit gripping device, and inserting the preassembly into the inboard end of the annular fitting component to interlock an outboard second interlock portion of the retaining device with the interior wall of the annular fitting component, such that the retaining device holds said annular fitting component and said conduit gripping device together as a discrete subassembly.

In accordance with another embodiment of one or more of the inventions presented in this disclosure, a method of pre-assembling first and second conduit gripping devices together as a preassembly includes the steps of providing a first conduit gripping device including a rear portion defining a first outer radial surface and a second conduit gripping device including a front portion defining a second outer radial surface, and assembling a retaining device with the first and second conduit gripping devices, such that a first interlock portion of the retaining device interlocks with the first outer radial surface of the first conduit gripping device, and a second interlock portion of the retaining device interlocks with the second outer radial surface of the second conduit gripping device, to hold the first conduit gripping device and the second conduit gripping device together as a discrete subassembly.

These and other aspects and advantages of the inventions described herein will be readily appreciated and understood by those skilled in the art in view of the accompanying drawings.

### BRIEF DESCRIPTION OF THE DRAWINGS

FIG. 1 is a longitudinal cross-sectional view of a cartridge nut and ferrule subassembly for a fitting, according to an exemplary embodiment of the present application;

FIG. 1A is an enlarged view of the circled region of FIG. 1;

FIG. 2 is a longitudinal cross-sectional view of a fitting including the cartridge subassembly of FIG. 1, shown in a finger tight condition;

FIG. 2A is an enlarged view of the circled region of FIG. 2;

FIG. 3 is a longitudinal cross-sectional view of the fitting of FIG. 2, shown in a pulled-up condition;

FIG. 3A is an enlarged view of the circled region of FIG. 3;

FIG. 4 is a longitudinal cross-sectional view of a cartridge nut and ferrule subassembly for a fitting, according to an exemplary embodiment of the present application;

FIG. 4A is an enlarged view of the circled region of FIG. 4;

FIG. 5 is a longitudinal cross-sectional view of a fitting including the cartridge subassembly of FIG. 4, shown in a finger tight condition;

FIG. 5A is an enlarged view of the circled region of FIG. 5;

FIG. 6 is a longitudinal cross-sectional view of the fitting of FIG. 5, shown in a pulled-up condition;

FIG. 6A is an enlarged view of the circled region of FIG. 6;

FIG. 7 is a longitudinal cross-sectional view of a cartridge nut and ferrule subassembly for a fitting, according to an exemplary embodiment of the present application;

FIG. 7A is an enlarged view of the circled region of FIG. 7;

FIG. 8 is a longitudinal cross-sectional view of a fitting including the cartridge subassembly of FIG. 7, shown in a finger tight condition;

FIG. 8A is an enlarged view of the circled region of FIG. 8;

FIG. 9A is an enlarged partial cross-sectional view of the ferrule retaining arrangement of the fitting of FIG. 8, shown in a cartridged condition;

FIG. 9B is an enlarged partial cross-sectional view of the ferrule retaining arrangement of the fitting of FIG. 8, shown in a partially pulled up (but still cartridged) condition;

FIG. 9C is an enlarged partial cross-sectional view of the ferrule retaining arrangement of the fitting of FIG. 8, shown in a partially pulled up, released condition;

FIG. 9D is an enlarged partial cross-sectional view of the of the ferrule retaining arrangement of the fitting of FIG. 8, shown in a complete pulled up, released condition;

FIG. 10 is a longitudinal cross-sectional view of a fitting including a cartridge subassembly, shown in a finger tight condition, according to an exemplary embodiment of the present application;

FIG. 10A is an enlarged view of the circled region of FIG. 10;

FIG. 10B is an enlarged partial cross-sectional view of the ferrule retaining arrangement of the fitting of FIG. 10, shown in a pulled up, released condition;

FIG. 11 is a longitudinal cross-sectional view of a cartridge nut and ferrule subassembly for a fitting, according to an exemplary embodiment of the present application;

FIG. 11A is an enlarged view of the circled region of FIG. 11;

FIG. 11B is an enlarged partial cross-sectional view of a cartridge nut and ferrule subassembly for a fitting, according to another exemplary embodiment of the present application;

FIG. 12 is a longitudinal cross-sectional view of a fitting including the cartridge subassembly of FIG. 11, shown in a finger tight condition;

FIG. 12A is an enlarged view of the circled region of FIG. 12;

FIG. 12B is an enlarged partial cross-sectional view of the ferrule retaining arrangement of the fitting of FIG. 12, shown in a pulled up, released condition;

FIG. 13 is a longitudinal cross-sectional view of a cartridge nut and ferrule subassembly for a fitting, according to an exemplary embodiment of the present application;

FIG. 13A is an enlarged view of the circled region of FIG. 13;

FIG. 14 is a longitudinal cross-sectional view of a fitting including the cartridge subassembly of FIG. 13, shown in a finger tight condition;

FIG. 14A is an enlarged view of the circled region of FIG. 14;

FIG. 14B is an enlarged partial cross-sectional view of the ferrule retaining arrangement of the fitting of FIG. 14, shown in a pulled up, released condition;

FIG. 15 is a longitudinal cross-sectional view of a fitting including a cartridge subassembly, shown in a finger tight condition, according to an exemplary embodiment of the present application;

FIG. 16 is a partial longitudinal cross-sectional view of the fitting of FIG. 15, shown in a pulled up condition;

FIG. 17 is a longitudinal cross-sectional view of a cartridge nut and ferrule subassembly for a fitting, according to an exemplary embodiment of the present application;

FIG. 17A is an enlarged view of the circled region of FIG. 17;

FIG. 18 is a longitudinal cross-sectional view of a fitting including the cartridge subassembly of FIG. 17, shown in a finger tight condition;

FIG. 18A is an enlarged view of the circled region of FIG. 18;

FIG. 18B is an enlarged partial cross-sectional view of the ferrule retaining arrangement of the fitting of FIG. 18, shown in a pulled up, released condition;

FIG. 19 is a longitudinal cross-sectional view of a fitting including a cartridge subassembly, shown in a finger tight condition, according to an exemplary embodiment of the present application;

FIG. 19A is an enlarged view of the circled region of FIG. 19;

FIG. 19B is an enlarged partial cross-sectional view of the ferrule retaining arrangement of the fitting of FIG. 19, shown in a pulled up, released condition;

FIG. 20 is a longitudinal cross-sectional view of a fitting assembly, shown in a loosely assembled condition, according to an exemplary embodiment of the present application;

FIG. 20A is a longitudinal cross-sectional view of a front and rear ferrule of a fitting, shown in an uncartridged condition;

FIG. 20B is an enlarged view of the circled region of FIG. 20;

FIG. 20C is a partial cross-sectional view of the front and rear ferrules of FIG. 20, shown with a crimping assembly tool;

FIG. 20D is an enlarged partial cross-sectional view of the front and rear ferrules of FIG. 20, shown in a cartridged condition;

FIG. 21 is a partial longitudinal cross-sectional view of a fitting including a cartridge subassembly, shown in a finger tight condition, according to an exemplary embodiment of the present application;

FIG. 22 is a partial longitudinal cross-sectional view of the fitting of FIG. 21, shown in a pulled up condition;

FIG. 23 is a partial longitudinal cross-sectional view of a fitting including a cartridge subassembly, shown in a finger tight condition, according to an exemplary embodiment of the present application;

FIG. 24 is a partial longitudinal cross-sectional view of the fitting of FIG. 23, shown in a pulled up condition;

FIG. 25 is a partial longitudinal cross-sectional view of a fitting including a cartridge subassembly, shown in a finger tight condition, according to an exemplary embodiment of the present application;

FIG. 25A is a partial longitudinal cross-sectional view of a fitting including a cartridge subassembly, shown in a finger tight condition, according to an exemplary embodiment of the present application;

FIG. 25B is a partial longitudinal cross-sectional view of a fitting including a cartridge subassembly, shown in a finger tight condition, according to an exemplary embodiment of the present application;

FIG. 26 is a partial longitudinal cross-sectional view of the fitting of FIG. 25, shown in a pulled up condition;

FIG. 26A is a partial longitudinal cross-sectional view of the fitting of FIG. 25A, shown in a pulled up condition;

FIG. 26B is a partial longitudinal cross-sectional view of the fitting of FIG. 25B, shown in a pulled up condition;

FIG. 27 is a partial longitudinal cross-sectional view of a fitting including a cartridge subassembly, shown in a finger tight condition, according to an exemplary embodiment of the present application;

FIG. 28 is a partial longitudinal cross-sectional view of the fitting of FIG. 27, shown in a pulled up condition;

FIG. 29 is a longitudinal cross-sectional view of a cartridge nut and ferrule subassembly for a fitting, according to an exemplary embodiment of the present application;

FIG. 30 is an enlarged partial cross-sectional view of the nut and ferrule subassembly of FIG. 29, showed in a pulled up condition;

FIG. 31 is a longitudinal cross-sectional view of a fitting including a cartridge subassembly, shown in a finger tight condition, according to an exemplary embodiment of the present application;

FIG. 31A is a perspective cross-sectional view of the fitting of FIG. 31;

FIG. 31B is another perspective cross-sectional view of the fitting of FIG. 31;

FIG. 32 is a is a longitudinal cross-sectional view of a cartridge nut and ferrule subassembly for a fitting, according to an exemplary embodiment of the present application;

FIG. 32A is an enlarged view of a first circled region of FIG. 32;

FIG. 32B is an enlarged view of a second circled region of FIG. 32;

FIG. 33 is a longitudinal cross-sectional view of a fitting including a cartridge subassembly, shown in a finger tight condition, according to an exemplary embodiment of the present application;

FIG. 33A is a side view of a ferrule and a cross-sectional view of a fitting nut from a nut and ferrule subassembly, according to an exemplary embodiment of the present application;

FIG. 33B is a side view of a ferrule and a cross-sectional view of a fitting nut from another nut and ferrule subassembly, according to an exemplary embodiment of the present application;

FIG. 34 is a perspective view of a fitting component retaining device, according to an exemplary embodiment of the present application;

FIG. 34A is a partial enlarged perspective view of the retaining device of FIG. 34;

FIG. 35 is a partial cross-sectional side view of a fitting nut and ferrule preassembly including the retaining device of FIG. 34;

FIG. 36 is a perspective view of a fitting component retaining device, according to an exemplary embodiment of the present application;

FIG. 36A is a partial enlarged perspective view of the retaining device of FIG. 36;

FIG. 37 is a partial cross-sectional side view of a front ferrule and rear ferrule preassembly including the retaining device of FIG. 36;

FIG. 38 is a perspective view of a fitting component retaining device, according to an exemplary embodiment of the present application;

FIG. 38A is a partial enlarged perspective view of the retaining device of FIG. 38;

FIG. 39 is a partial cross-sectional side view of a front ferrule aligned with the retaining device of FIG. 38 prior to assembly;

FIG. 40 is a partial cross-sectional side view of the front ferrule of FIG. 39 assembled with the retaining device of FIG. 38, with a rear ferrule aligned with the retaining device prior to assembly;

FIG. 41 is a partial cross-sectional side view of the front ferrule of FIG. 39 and the rear ferrule of FIG. 40 assembled with the retaining device of FIG. 38;

FIG. 42 is a partial cross-sectional side view of the ferrule preassembly of FIG. 41, with a fitting nut aligned with the retaining device prior to assembly; and

FIG. 43 is a partial cross-sectional side view of the front ferrule of FIG. 39, the rear ferrule of FIG. 40, and the fitting nut of FIG. 42, assembled and retained together as a preassembly by the retaining device of FIG. 38.

### DESCRIPTION OF THE EXEMPLARY EMBODIMENTS

Although the exemplary embodiments herein are presented in the context of a stainless steel tube fitting, the inventions herein are not limited to such applications, and will find use with many different conduits such as tube and pipe as well as many different suitable materials, including metals and non-metals for either the conduit, the gripping devices or the fitting components or any combination thereof. Exemplary materials include various stainless steels, including, for example, 316 stainless steel, 304 stainless steel, AL-6XN stainless steel alloy, 254 SMO stainless steel alloy, Inconel® alloy 625 stainless steel, and Incoloy® alloy 825 stainless steel, as well as Hastelloy®, brass, titanium, and aluminum, to name a few examples. The inventions may also be used for liquid or gas fluid systems. While the inventions herein are illustrated with respect to particular designs of the conduit gripping devices and fitting components, the inventions are not limited to use with such designs, and will find application in many different fitting designs that use one or more conduit gripping devices. We use the term “conventional” to refer to commercially available or later developed parts or parts that are otherwise commonly known, used or that those of ordinary skill in the art would be familiar with in general, as distinguished from parts that may be modified in accordance with teachings herein. We use the term “ferrule set” to refer to a combination of conduit gripping devices with or without other parts that form the means by which conduit grip and seal are achieved. In one example, one or more conduit gripping members may include heat treated hardened ferrules, with the heat treating being, for example, a case hardening of stainless steel or some other metal alloy by a lower temperature interstitial (e.g., carbon, nitrogen, or both) diffusion into the metal ferrule. Although not necessary with all fitting designs, it is common that a ferrule set comprises two ferrules that are purposely matched to each other and to the fitting components, for example, based on material, manufacturer, interrelated design and geometry features and so on. In some fittings, in addition to the conduit gripping devices there may be one or more additional parts, for example seals. Therefore, the term “ferrule set” may also include in some embodiments the combination of one or more conduit gripping devices with one or more other parts by which the ferrule set effects conduit grip and seal after a complete pull-up. The inventions may be used with tube or pipe, so we use the term “conduit” to include tube or pipe or both. We generally use the term “fitting assembly” or “fitting” interchangeably as a shorthand reference to an assembly of typically first and second fitting components along with one or more conduit gripping devices. The concept of a “fitting assembly” thus may include assembly of the parts onto a conduit, either in a finger-tight position, a partial pull-up position or complete pull-up position; but the term “fitting assembly” is also intended to include an assembly of parts together without a conduit, for example for shipping or handling, as well as the constituent parts themselves even if not assembled together.

The term “complete pull-up” and derivative forms as used herein refers to joining the fitting components together so as to cause the one or more conduit gripping devices to deform, usually but not necessarily plastically deform, to create a fluid tight seal and grip of the fitting assembly on the conduit. A “partial pull-up” and derivative terms as used herein refers to a partial but sufficient tightening of the male and female fitting components together so as to cause the conduit gripping device or devices to deform so as to be radially compressed against and thus attached to the conduit, but not necessarily having created a fluid tight connection or the required conduit grip that is achieved after a complete pull-up. The term “partial pull-up” thus may also be understood to include what is often referred to in the art as pre-swaging wherein a swaging tool is used to deform the ferrules onto the conduit sufficiently so that the ferrules and the nut are retained on the conduit prior to being mated with the second fitting component to form a complete fitting assembly. A finger tight position or condition refers to the fitting components and conduit gripping devices being loosely assembled onto the conduit but without any significant tightening of the male and female fitting components together, usually typified by the conduit gripping device or devices not undergoing plastic deformation.

Fittings typically include two fitting components that are joined together, and one or more gripping devices, however, the inventions herein may be used with fittings that include additional pieces and parts. For example, a union fitting may include a body and two nuts. We also use the term “fitting remake” and derivative terms herein to refer to a fitting assembly that has been at least once tightened or completely pulled-up, loosened, and then re-tightened to another completely pulled-up position. Remakes may be done with the same fitting assembly parts (e.g. nut, body, ferrules), for example, or may involve the replacement of one of more of the parts of the fitting assembly. Reference herein to “outboard,” “axially outward,” “inboard,” and “axially inward” are for convenience and simply refer to whether a direction is towards the center of a fitting (inboard or axially inward) or away from the center (outboard or axially outward). In the drawings, various gaps and spaces between parts (for example, gaps between the ferrules and the conduit in a finger-tight position) may be somewhat exaggerated for clarity or due to scale of the drawings.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

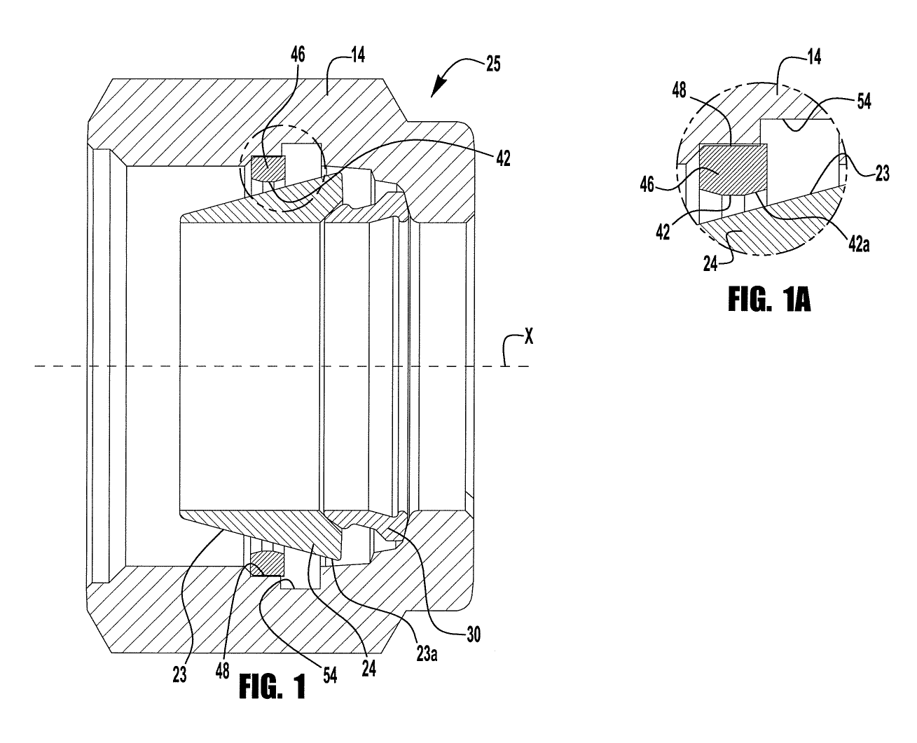

With general reference to FIGS. 1-3A, an exemplary embodiment of one or more of the inventions is presented. Note that in many of the drawings herein, the fittings are illustrated in longitudinal or half longitudinal cross-section, it being understood by those skilled in the art that the fitting components are in practice annular parts about a longitudinal centerline axis X. All references herein to “radial” and “axial” are referenced to the X axis except as otherwise noted. Also, all references herein to angles are referenced to the X axis except as may be otherwise noted.

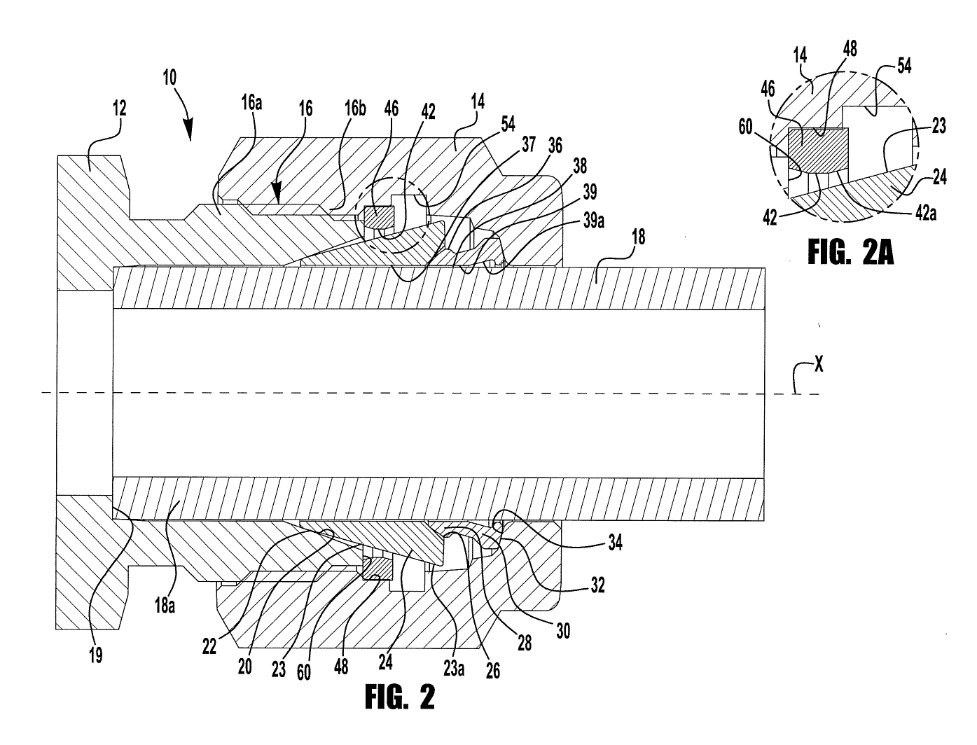

In this disclosure unless otherwise noted, as shown in FIGS. 2 and 3, a fitting assembly 10 may include a first coupling or fitting component 12 and a second coupling or fitting component 14. These parts are commonly known in the art as a body and nut respectively, wherein the body 12 receives a conduit 18 end shown in phantom in FIG. 2, and the nut 14 may be joined to the body 12 during make up of the fitting. Although we use the common terms of body and nut herein as a convenience, those skilled in the art will appreciate that the inventions are not limited to applications wherein such terminology may be used to describe the parts. The body 12 may be a stand-alone component as illustrated or may be integral with or integrated or assembled into another component or assembly such as, for example, a valve, a tank or other flow device or fluid containment device. The body 12 may have many different configurations, for example, a union, a tee, or an elbow, to name a few that are well known in the art. Although the body 12 and nut 14 are illustrated as being threadably joined together by a threaded connection 16, threaded connections are not required in all uses. For example, some fittings have parts that are clamped together. Fittings are also commonly referred to in the art as male fittings or female fittings, with the distinction being that for a male fitting (FIGS. 2 and 3), the male body 12 includes an externally threaded portion 16a and the female nut 14 includes an internally threaded portion 16b. For a female fitting (not shown), the male nut includes an externally threaded portion and the female body includes an internally threaded portion. Many of the exemplary embodiments herein illustrate a male fitting assembly embodiment, for example, but the inventions herein also may be conveniently adapted for use with a female fitting assembly. When the fitting components, such as a body and nut for example, are joined they form a generally enclosed interior space or volume for the conduit gripping devices or other optional seal components.

The fitting assembly 10 may be used to form a fluid tight connection between an end portion 18a of a conduit 18 and the body 12 using one or more conduit gripping devices, which in the exemplary embodiments herein may be realized in the form of one or more ferrules. However, conduit gripping devices other than those that may be understood in the art as ‘ferrules’ may also be used with the inventions herein. The conduit end 18a typically bottoms against a radial shoulder 19 (FIG. 2) that is part of the body 12, as is well known. The body 12 includes a tapered camming surface 20 that engages the front portion 22 of a first or front conduit gripping device or ferrule 24. The front ferrule 24 includes a tapered camming surface 26 at its back end that engages a front portion 28 of a second or back conduit gripping device or ferrule 30. The rear ferrule 30 includes a driven surface 32 that engages a drive surface 34 of the female nut 14. The rear ferrule front portion 28 may optionally include a radially extending crown 36. The front and rear ferrules include cylindrical interior walls 37, 39 that are closely received over the outer surface 38 of the conduit 18. The rear ferrule may optionally include one or more radial recesses 39a. Although the exemplary embodiments herein illustrate fitting assemblies that use a conduit gripping device or ferrule set having two conduit gripping devices or ferrules, the inventions will readily find application to fittings that may use only a single conduit gripping device or ferrule, as well as fittings that may use ferrule sets having more than two conduit gripping devices, or additional parts other than just ferrules or conduit gripping devices, for example, additional seals.

It is important to note that the exemplary geometric shapes, configurations and designs of the fitting coupling components 12, 14, and the conduit gripping devices 24, 30 are a matter of design choice and will depend in great measure on the materials used, and the design and performance criteria expected of the fitting. Many different coupling components and conduit gripping device designs are known in the art and may be designed in the future.

FIGS. 2 and 2A illustrate the fitting assembly 10 in a finger-tight condition, meaning that the various parts 12, 14, 24 and 30 have been assembled onto the conduit 18 (illustrated in phantom for clarity) but are loosely assembled or slightly tightened or snugged up by manually joining the nut 14 and body 12 together. Fittings are commonly pulled-up to a complete pulled-up position, shown in FIGS. 3 and 3A, by counting complete and partial turns of the nut 14 relative to the body 12 from the finger-tight position. The present inventions, however, may be used with fitting designs that alternatively may be pulled-up by torque. During pull-up, the ferrules 24, 30 plastically deform to effect a conduit grip and seal. In an exemplary embodiment, the front ferrule 24 is driven radially inward at the nose portion (by the camming mouth of the fitting body) to bite into the conduit, and radially outward at the rear portion (by the nose portion of the rear ferrule 30), while the rear ferrule 30 nose is compressed radially inward and the rear flange is expanded radially outward in a hinging action. In other embodiments, one or more conduit gripping devices may utilize other types of deformation to effect a conduit grip and seal.

A significant feature of some of the inventions herein is the provision of a retaining structure by which one or more conduit gripping devices are retained with a fitting component, also referred to herein as a retaining fitting component, prior to assembly of the fitting component with a mating fitting component. By “cartridge” we mean a group of parts retained together as a discontinuous unit, subassembly or preassembly. We therefore use the terms cartridge, unit, subassembly and preassembly synonymously herein in the context of a discontinuous structure. We also use the term “cartridge nut” or “conduit fitting cartridge” herein to refer to such a cartridge, unit or subassembly in which one or more conduit gripping devices are retained with a fitting component such as a female nut, for example. We also use the term “ferrule cartridge” or “conduit gripping device cartridge” to refer to a unit or subassembly made up of at least one ferrule or conduit gripping device with at least one other part held together as a discrete unit. In particular, a “ferrule cartridge” includes two or more ferrules held together as a discrete unit or subassembly, and may include additional parts, for example, seals. In the exemplary embodiments herein, the cartridge includes one or more ferrules retained with a fitting component, such as a female threaded nut. Therefore, the exemplary embodiments herein may be referred to as a cartridge nut design, however in alternative embodiments, a “cartridge nut” may include a male threaded cartridge nut design or a cartridge body design.

As one aspect of the present application, use of a discontinuous fitting component cartridge may facilitate providing ferrule sets to the end user in which the ferrules and nuts are properly oriented, matched, and assembled at the manufacturer. This can significantly simplify inventory control and reduce final assembly time. The embodiments herein also allow for a cartridge design in which the retaining fitting component may be used for fitting assemblies that do not need or have the retaining member. In other words, the cartridge designs herein use a nut or retaining fitting component that is backwards compatible with fitting assemblies that the end user may not require with a retaining structure. The cartridge design also may be realized using ferrule sets that do not require modification. Therefore, the cartridge concepts herein may be optionally provided for an end user without having to manufacture nuts or ferrules with different geometry and operation or performance. This allows the convenience of manufacturing and selling fitting components and ferrules as separate parts regardless of the end use of such individual parts, either for a cartridge use or a non-cartridge use.

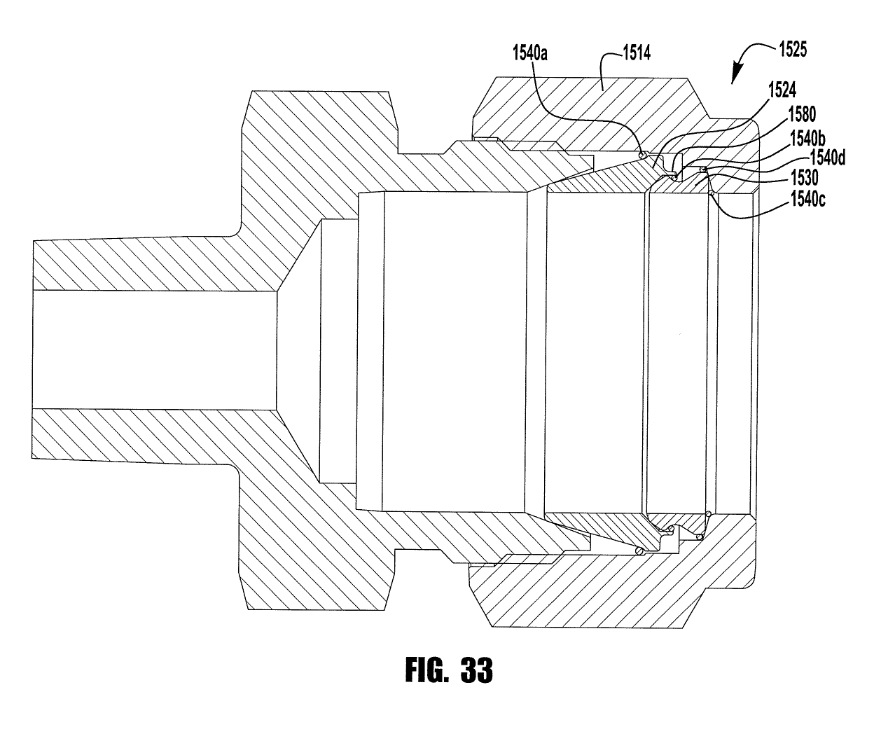

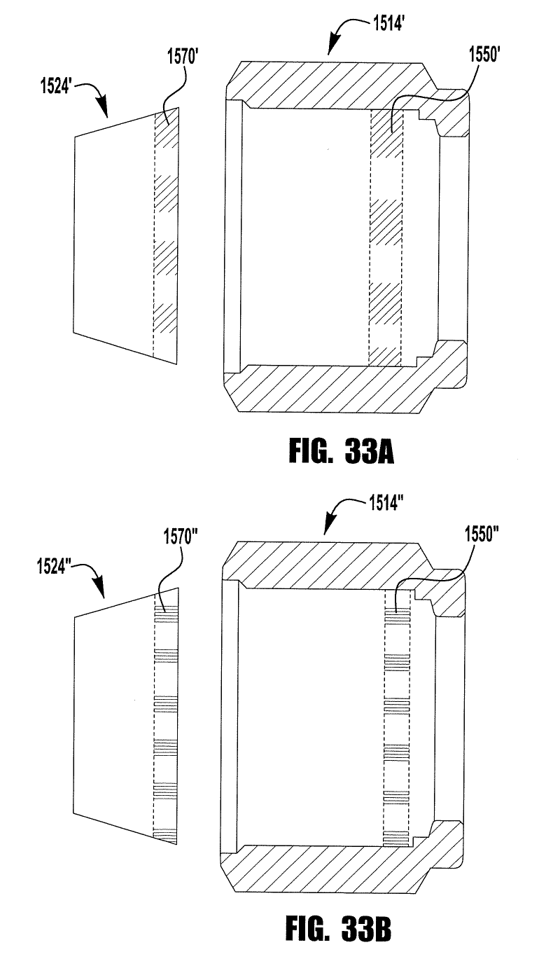

Exemplary cartridge nut arrangements are described in co-owned U.S. Pat. No. 8,931,810 (THE “'810 Patent”), U.S. patent application Ser. No. 15/248,288 (the “'288 Application”), filed on Aug. 26, 2016 and titled COMPONENT RETAINING STRUCTURE FOR CONDUIT FITTING, and U.S. patent application Ser. No. 15,416,048 (the “'048 Application”), filed of Jan. 26, 2017 and titled COMPONENT RETAINING STRUCTURE FOR CONDUIT FITTING, the entire disclosures of each of which are incorporated herein by reference. In some embodiments of the '810 Patent and the '288 Application (see, e.g., the embodiments of FIGS. 33-37 of the '810 Patent and the embodiments of FIGS. 1-6 of the '288 Application), a component retaining or cartridging structure includes a separate retaining ring that that retains or captures an outer radial portion of the conduit gripping device within the fitting nut when the retaining ring is in a first, cartridging position. When the fitting is pulled up, an outboard end portion of the fitting body axially pushes the retaining ring end portion within the fitting nut into alignment with a circumferential recess in the fitting nut, into which the aligned retaining ring snaps radially outward to radially separate from the outer radial portion of the front ferrule, to permit withdrawal or removal of the ferrules from the fitting nut.

In exemplary embodiments of the '288 Application (see FIGS. 1-6 of the '288 Application), the front ferrule is provided with a back-end flange that defines the outer radial portion of the ferrule. This flange abuts the retaining ring when the front ferrule is in an axially forward or inboard position so as to hold the ferrules and the nut together as a discontinuous cartridge. Further, to prevent the retaining member from being bumped, jostled, or otherwise prematurely forced into the ferrule releasing recess, the ferrules may be arranged such that prior to deformation of the ferrules associated with a pull-up of the fitting (e.g., a full or partial pull-up of the fitting), the ferrules block movement of the retaining ring into axial alignment with the recess. When the fitting is pulled up by a sufficient amount, the front and rear ferrules are deformed such that the back flange of the front ferrule is axially and/or radially displaced from the recessed portion, thereby permitting movement of the retaining member into axial alignment with the recessed portion.

According to an exemplary aspect of the present application, a retaining ring for use in a retaining fitting component (e.g., fitting nut), utilizing one or more of the features of the above incorporated '810 Patent and '288 and '048 Applications, may be sized and contoured for use with a conduit gripping device (e.g., front ferrule or single ferrule) provided with a more conventional frustoconical outer radial surface (i.e., without an enlarged back end flange), for example, to allow for use with existing conventionally shaped ferrules. In one such embodiment, the retaining ring includes an axially and/or radially enlarged cross section (e.g., as compared to the retaining ring of the embodiment of FIGS. 1-6 of the '288 Application) to engage a portion of the frustoconical outer surface radially and axially inward of the outer rear end portion of the ferrule, to block alignment of the retaining ring with the fitting nut recess prior to pull-up, and/or to block alignment of the rear end portion of the ferrule with the recess (e.g., to prevent the ferrule rear end from being cocked or otherwise received in the recess). Additionally, the retaining ring may be provided with an inner radial surface contoured to allow axial movement of the retaining ring towards the ferrule during pull-up by an amount sufficient to align the retaining ring with the recess.

In the illustrated embodiment of FIGS. 1-3A, a retaining ring 46 is provided for retaining the conduit gripping devices 24, 30 together with one of the fitting nut 14 as a discontinuous unit, cartridge, preassembly or subassembly 25 prior to connecting with the mating fitting component so as to install the conduit gripping devices onto the conduit 18. The retaining ring 46 includes an inner radial ferrule retaining portion 42 engageable with the front ferrule 24. The front ferrule 24 includes a substantially frustoconical inboard facing outer wall surface 23 that extends substantially continuously (e.g., disposed at a continuous angle of about 15° with respect to the longitudinal axis X) from a front end or nose portion 22 of the front ferrule 24 to a rear end portion 23a of the front ferrule.

In the illustrated embodiment, the retaining ring is disposed in a first axial position or retaining position in the pre-assembled stand alone cartridge 25 (FIG. 1), and may remain in the retaining position when the cartridge 25 is joined with the mating fitting component in the finger tight position, as shown in FIG. 2. As a result of, for example, a partial or complete pull-up, the retaining ring 46 is engaged by an axially outer end face 60 of the fitting body 12 and driven to a second axial position or release position. In this exemplary embodiment, the retaining ring 46 moves axially and radially relative to the fitting nut to the release or disengage position of FIG. 3, as understood in comparing FIG. 3 with the retaining position of FIG. 2. The retaining arrangement preferably is designed so as to not interfere with normal operation and pull-up of the ferrules onto the conduit to effect grip and seal, or with remakes of the fitting.

The exemplary nut 14 includes a first interior portion 48 that receives the retaining ring 46 to position the retaining ring 46 in the retaining, first axial position. This first portion may be recessed from an axially inner end of the nut 14 to prevent the retaining ring from being axially withdrawn from the nut. The nut 14 further includes a second recessed portion or pocket 54, formed in an interior surface of the nut that axially locates the release or second axial position of the retaining member 46. The recessed portion 54 may be axially adjacent the first axial position of the retaining member, or may be further axially spaced therefrom as needed. The exemplary recessed portion has a greater radial dimension than the portion of the nut in which the retaining member is disposed in the first axial position, so that the retaining member 46 is restricted to the first radial position when in the first axial position, and can expand radially outwardly to the second radial position when aligned with the recessed portion in the second axial position. The second radial recess 54 thus axially locates the release position. The radial depth of the second radial recess 54 may be chosen so that when the retaining member 46 is located therein, the retaining member no longer adversely interferes with the conduit gripping devices 24, 30 (e.g., providing for radial clearance of the retaining member 46 from the front ferrule 24, or providing for minimal radial interference between the retaining member and the front ferrule so as to permit manual axial disengagement of the nut 14 from the front ferrule 24 when the nut is manually loosened from the fitting body 12).

The second axial position of the retaining member (e.g., as determined by an axial location of the recessed portion 54 of the nut 14) may be chosen in concert with the amount of relative axial displacement of the nut 14 and the body 12 to determine at what point during pull-up the retaining member 46 is transposed to the release position by being moved into the recessed portion 54. For example, it may be desired in some embodiments to have the retaining member 46 be displaced to the release position upon completion of a pull-up operation, prior to completion of a pull-up operation, upon completion of a pre-swage operation, or upon tightening to a partial pull-up condition that is sufficient to cause the conduit gripping devices to begin plastically deforming the conduit, such that subsequent loosening or separation of the retaining fitting component from the mating fitting component permits the released conduit gripping devices to maintain gripping engagement with the deformed conduit surfaces.

To accommodate the axial movement of the retaining ring 46 during pull-up, the inner radial surface of the retaining ring may be shaped to provide radial clearance for the front ferrule 24 during pull-up of the fitting, as the retaining ring is pushed axially outward, prior to snapping radially outward into the recess, and as the rear portion of the front ferrule is expanded radially outward and driven axially outward into the nut. As shown, the inner radial portion 42 of the retaining ring 46 includes a chamfered or otherwise contoured surface 42a shaped to provide clearance for the rear portion of the front ferrule 24 to allow for axially outward travel of the retaining ring 46 into alignment with the nut recess 54. This contoured surface 42a may additionally provide for increased retaining engagement (e.g., along an expanded contact surface area) between the retaining ring 46 and the front ferrule 24, and/or to minimize marring of the engaging portions of the components, when the cartridged front ferrule is moved axially inward into engagement with the retaining ring. Accordingly, the contoured surface 42a of the inner radial portion 42 of the retaining ring 46 may form a frustoconical outboard facing surface complementary to (e.g., disposed at an angle within about 10° of) the frustoconical outer surface of the front ferrule (e.g., disposed at an angle of about 15° with respect to the longitudinal axis X) to provide for increased clearance and/or increased surface area contact between the retaining ring and the frustoconical rear end portion 23a. In some embodiments, the contoured surface 42a may be disposed at an angle slightly greater than the ferrule rear end angle (e.g., between about 15° and 25° for a ferrule having a rear end angle of 15°) to account for an increase in the ferrule surface angle due to rear end radial expansion during pull-up. As shown, the inner radial portion 42 of the retaining ring may be contoured on both sides to permit reversible installation of the retaining ring 46 in the nut 14.

While the second axial position of the retaining ring 46 may provide radial clearance between the retaining ring 46 and the front ferrule 24, as described above, in other embodiments, a certain amount of radial interference may remain between the retaining ring and front ferrule. This radial interference may be limited to permit axial disengagement of the nut 14 from the front ferrule 24, with the retaining member 46 functioning as a detent to provide only limited resistance to manual axial disengagement of the nut 14 from the front ferrule 24, when the nut is unthreaded or loosened from the fitting body 12.

In another embodiment, a radially outward biased, but further radially compressible, retaining ring of a cartridged nut and ferrule subassembly may be secured in a first, axially inner shallower recess of the nut to retain the ferrule or ferrules in the cartridge subassembly. The first recess is separated from a second, axially outer deeper recess of the nut by a ring retaining wall portion that extends radially inward of each of the first and second recesses. At least one of the retaining ring and the ring retaining wall portion includes a ramped surface to facilitate radial compression of the retaining ring in response to forced axial engagement of the retaining ring with the ring retaining wall portion. To axially move the retaining ring from the first recess to a second, axially outer recess of the nut, the retaining ring must be driven axially outward with enough force (e.g., during fitting pull-up) to further radially compress the retaining ring to clear the ring retaining wall portion before snapping radially outward into the second recess upon axial alignment with the second recess. When received in the second recess, the retaining ring radially expands away from radial alignment with the rear portion of the front ferrule to permit disassembly of the nut from the ferrules (e.g., providing radial clearance or minimal radial interference between the retaining ring and the front ferrule).

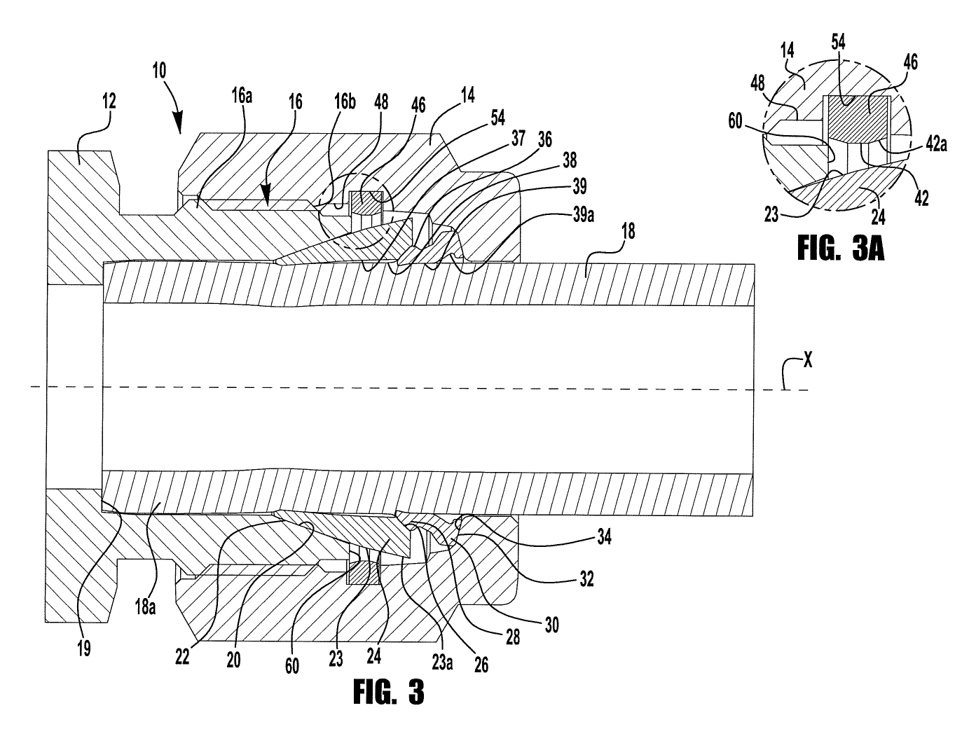

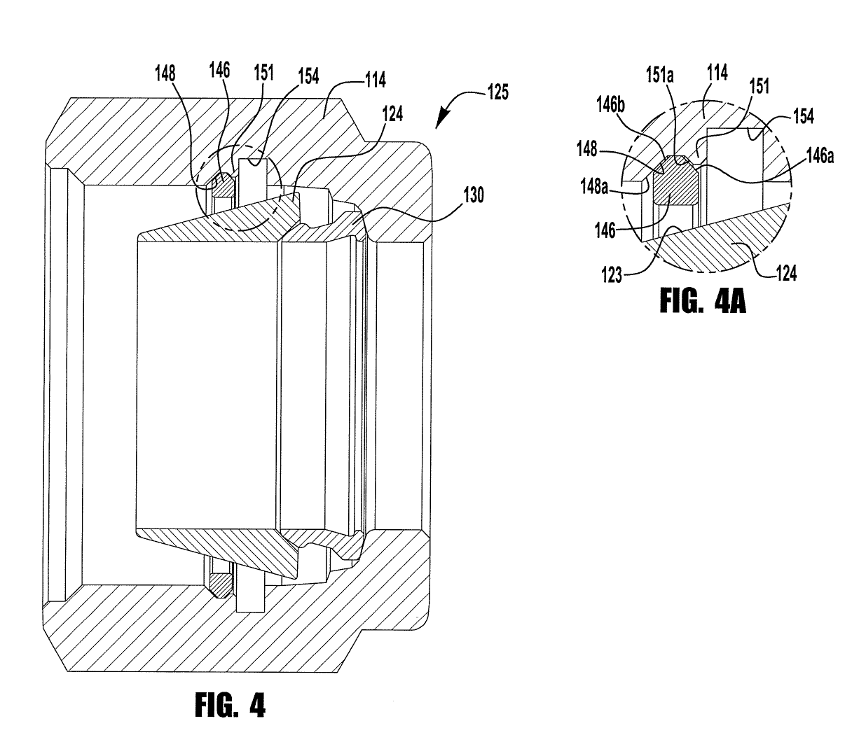

In the illustrated embodiment of FIGS. 4-6A, a cartridge nut and ferrule arrangement 125 includes a fitting nut 114, a retaining ring 146, and front and rear ferrules 124, 130. The nut 114 includes a first, axially inner shallower circumferential recess 148 and a second, axially outer deeper circumferential recess 154 separated by a ring retaining wall portion 151 that extends radially inward from each of the first and second recesses 148, 154. The first recess 148 may be formed separate from (e.g., axially outboard of) an internal threaded portion of the nut 114. Alternatively, the first recess 148 may be defined by the internal threads, with the retaining ring 146 being snapped into engagement with the threaded portion, or threaded into engagement with the threaded portion.

In the cartridged condition, the retaining ring 146 is received or seated in the first recess 148, such that an inner radial portion of the retaining ring radially aligns with the rear portion of the front ferrule 124 to block withdrawal of the ferrules 124, 130 from the nut 114. In the illustrated embodiment, an inboard surface 151a of the ring retaining wall portion 151 and an outboard surface 146a of the retaining ring 146 are similarly ramped to facilitate radial compression of the retaining ring 146 in response to forced axial engagement of the retaining ring outboard surface 146a with the inboard surface 151a of the ring retaining wall portion 151. As shown, the retaining ring 146 may include ramped surfaces 146a, 146b on both sides to permit reversible installation of the retaining ring 146 in the nut 114. Further, the first recess 148 may include a ramped inner surface 148a to permit forced axial extraction of the retaining ring 146 from the inboard end of the fitting nut, by facilitating radial compression of the retaining ring (e.g., by grasping and pulling the retaining ring using a tool inserted into the fitting nut). In other embodiments (not shown), only one of the wall portion inboard surface and the retaining ring outboard surface may be ramped, or the wall portion inboard surface and the retaining ring outboard surface may be differently contoured while still providing for radial compression of the retaining ring in response to forced axial engagement of the wall portion inboard surface with the retaining ring outboard surface.

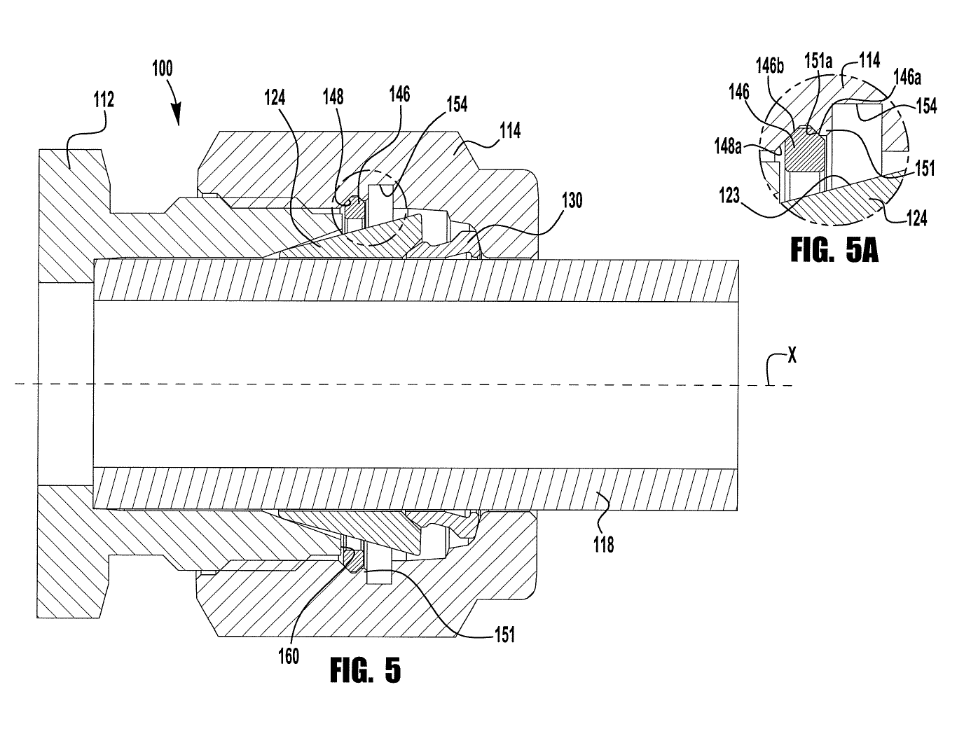

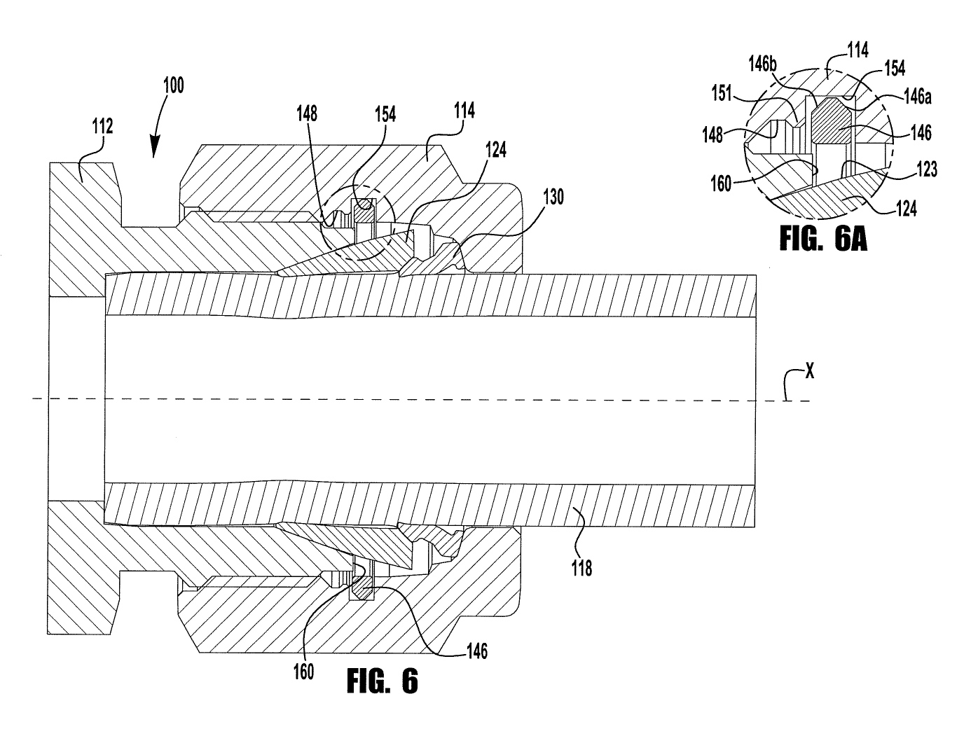

As shown in FIGS. 5 and 6, to axially move the retaining ring 146 from the first recess 148 to the second recess 154 during fitting pull-up, an axially outer end face 160 of the fitting body 112 engages the retaining ring 146 and axially drives the retaining ring outward to further radially compress the retaining ring to clear the ring retaining wall portion 151 before snapping radially outward into the second recess 154 upon axial alignment with the second recess. When received in the second recess, the retaining ring 146 radially expands away from radial alignment with the rear portion of the front ferrule 124 to permit disassembly of the nut 114 from the ferrules 124, 130, for example, to provide radial clearance between the retaining ring 146 and the front ferrule 124, or to limit radial interference to permit axial disengagement of the nut 114 from the front ferrule 124, with the retaining member 146 functioning as a detent to provide only limited resistance to manual axial disengagement of the nut 114 from the front ferrule 124, when the nut is unthreaded or loosened from the fitting body 112.

According to another aspect of the present application, a cartridging fitting arrangement may be provided with a retaining fitting component (e.g., a fitting nut) and a conduit gripping device (e.g., a single ferrule or a front ferrule of a two ferrule configuration) having an outer circumferential recess that axially captures a radially inward extending projection provided with or connected to an interior wall of the retaining fitting component (e.g., integral to or assembled with the retaining fitting component) to cartridge the conduit gripping device with the retaining fitting component. The projection may form a continuous ring around the interior wall, or one or more discrete spaced apart projections extending from the interior wall. When the fitting is pulled up, axial movement of the conduit gripping device with respect to the projection causes the projection to be plastically deformed into a recess disengaging condition, to permit disassembly of the retaining fitting component from the conduit gripping device.

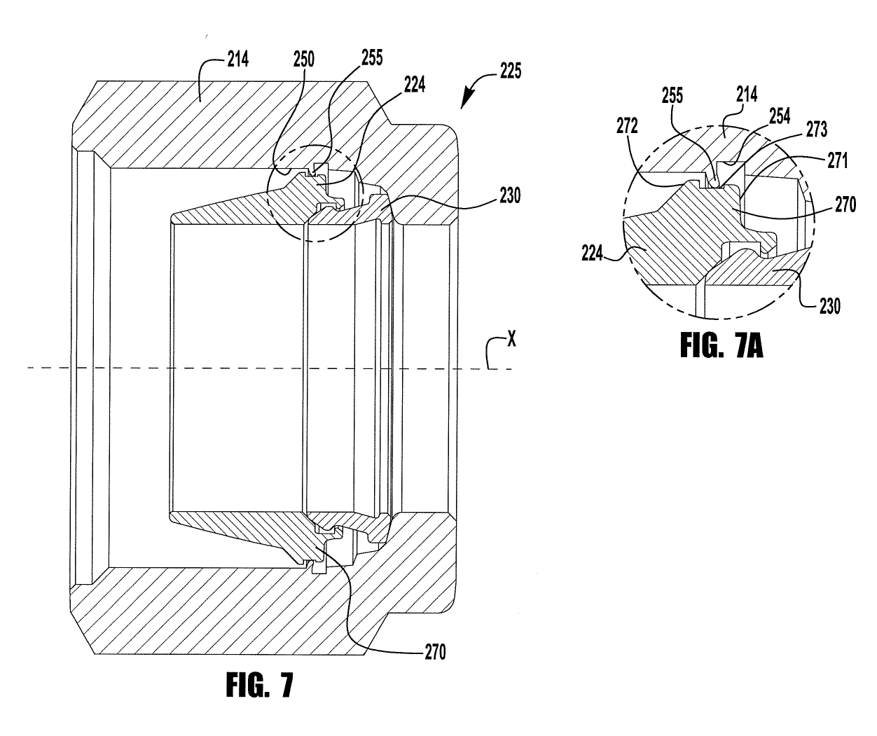

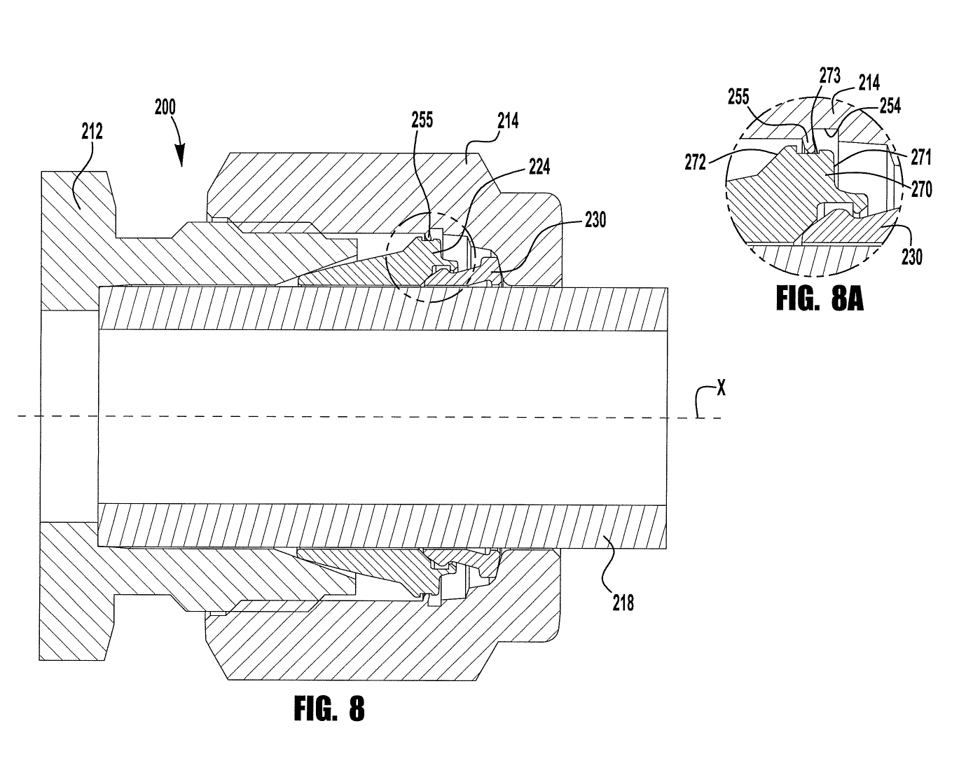

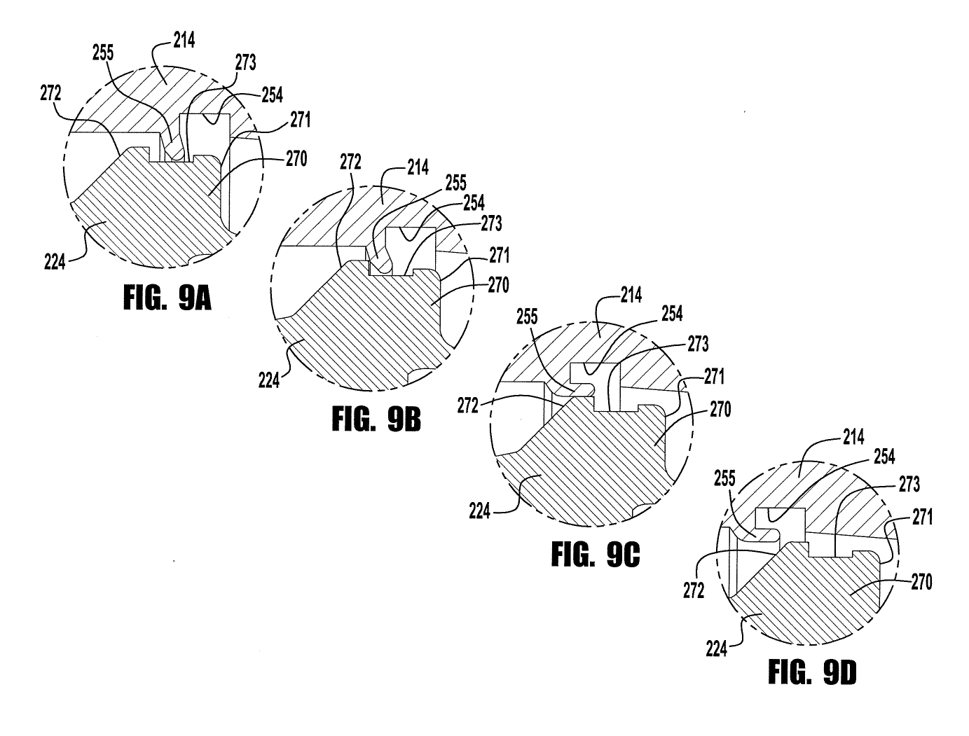

FIGS. 7-9D illustrate an exemplary cartridge nut and ferrule arrangement 225 including a fitting nut 214 and front and rear ferrules 224, 230. The nut 214 includes a flexible projection 255 that extends radially inward from an interior wall 250 of the fitting nut 214. When the ferrules 224, 230 are initially installed in the nut 214, an outboard end 271 of a rear flanged portion 270 of the front ferrule 224 engages the projection 255 and primarily elastically bends the projection to receive the projection in an outer circumferential recess 273 in the flanged portion 270, into which the projection elastically snaps for retention of the projection within the recess, and cartridged retention of the ferrules 224, 230 within the fitting nut 214. Some plastic deformation of the projection 255 may occur during cartridging, as evident in FIG. 9A. When the nut 214 is assembled with a fitting body 212, as shown in FIG. 8, and the nut is pulled up on the body, an inboard end 272 of the flanged portion 270 engages the projection 255 and plastically bends the projection out of engagement with the circumferential recess 273, as the flanged portion moves axially outward of the projection (as shown in the incremental enlarged views of FIGS. 9A-9D). In this plastically deformed condition of the projection, the nut 214 may be disassembled from the ferrules. In some embodiments, the deformed and disengaged projection may slightly radially interfere with the flanged portion 270 while still allowing for nut and ferrule disassembly (e.g., by further minimal outward bending deformation of the projection as the nut 214 is disassembled from the fitting body). As shown, the nut 214 may be provided with a recess 254 axially outward of the projection to facilitate axial outward plastic bending of the projection during pull-up. In other embodiments, the projection may be provided as a more flexible (and less plastically deformable) projection, such that the projection is bent axially and radially outward by an outer portion of a ferrule upon ferrule installation, snapping axially and radially inward to axially capture the ferrule, and then bending axially inward and radially outward during disassembly of the nut from the body of the pulled-up fitting.

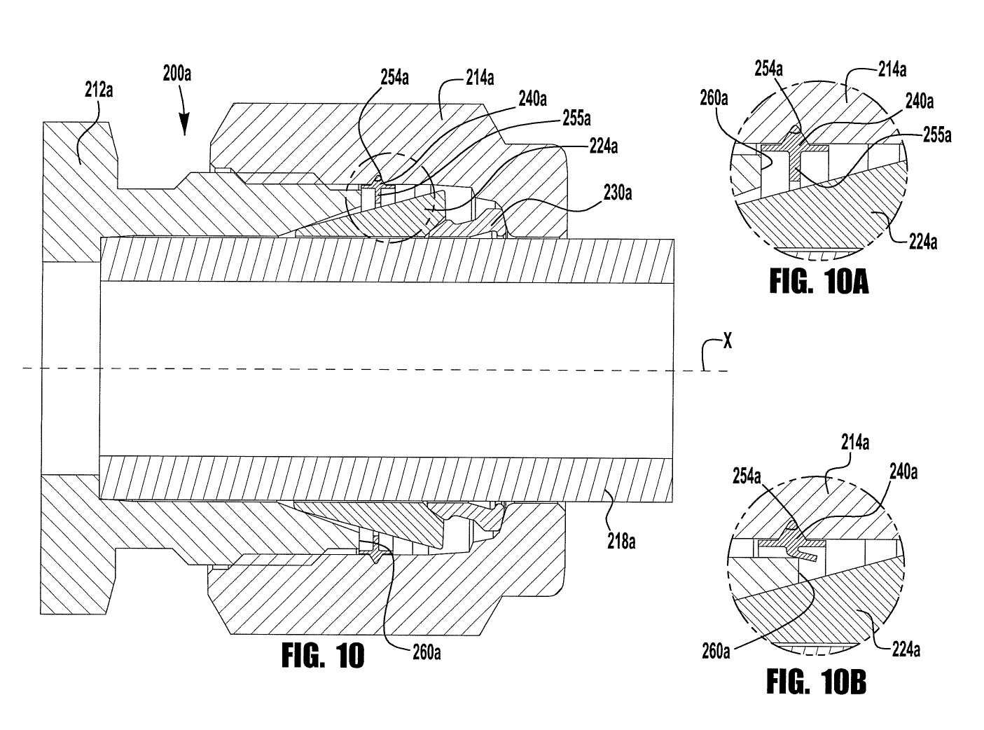

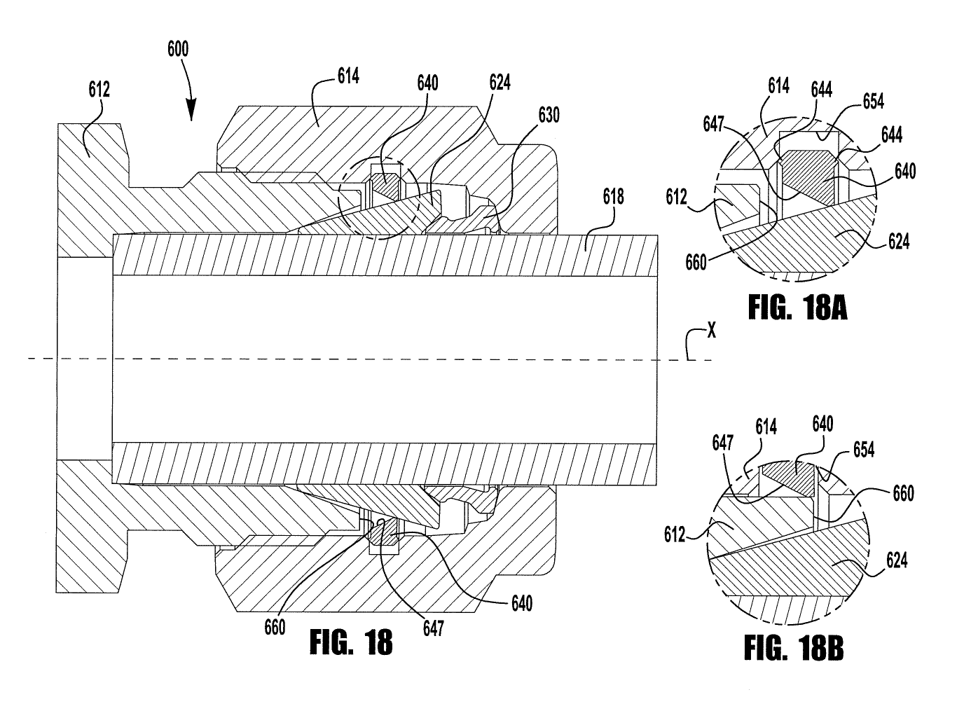

In still other embodiments, an insert having an axially bendable inward projection may be used to snap into retaining or cartridging engagement with an inboard facing outer surface (e.g., a frustoconical surface) of a conventional ferrule (e.g., single ferrule or front ferrule, similar to the integral nut projection embodiments of FIGS. 18-22 of the above incorporated '810 Patent). One such exemplary fitting 200a is shown in FIGS. 10, 10A, and 10B with a fitting nut 214a having a circumferential recess 254a retaining an annular insert 240a with an inward extending projection 255a that elastically bends to receive and retain front and rear ferrules 224a, 230a. The recess 254a may be formed separate from (e.g., axially outboard of) an internal threaded portion of the nut 214a. Alternatively, the recess may be defined by the internal threads, with the retaining insert 240a being snapped into engagement with the threaded portion, or threaded into engagement with the threaded portion. As shown in FIG. 10B, the fitting body 212a may include an end portion 260a that plastically deforms the projection 255a upon pull-up to disengage the projection 255a from the outer surface of the front ferrule, to allow for disassembly of the nut 212a from the pulled up ferrules 224a, 230a. In other embodiments, the flexible projection 255a may remain in radial interference with the front ferrule 224a, with the projection being bent axially inward and radially outward during unthreading or loosening of the nut 214a from the body 212a of the pulled-up fitting to permit axial disengagement of the nut from the front ferrule. In such embodiments, the projection 255a may be adapted for increased flexibility, for example, by providing a projection having one or more of the following: reduced thickness, material having increased flexibility (e.g., sponge-like material, such as a steel sponge material, spring-like material, or elastomeric material), or segmented or independently flexible features (e.g., tabs, strands, bristles, whiskers, pins, etc.).

In an exemplary method of assembling a preassembly for a conduit fitting, an annular fitting component is provided, having an interior wall extending along a central axis from an inboard end to an outboard end. At least a first conduit gripping device is inserted into the inboard end of the annular fitting component. A retaining member is inserted into the inboard end of the annular fitting component, such that an outer radial portion of the retaining member interlocks with a circumferential recess in the annular fitting component, and a radially inward extending projection is radially aligned with an outer radial portion of the first conduit gripping device to impede withdrawal of the first conduit gripping device from the inboard end of the annular fitting component.

In other embodiments, an insert having an axially bendable inward projection may be used to snap into retaining or cartridging engagement with an inboard facing surface of the rear ferrule (or a single ferrule in a single ferrule fitting configuration), to retain the rear ferrule with the fitting nut. In one such embodiment, this rear ferrule retaining arrangement may be used in combination with a cartridged front and rear ferrule arrangement, as described in greater detail below, to retain both the rear ferrule and the front ferrule with the nut.

In other embodiments, a radially inward extending projection provided with a retaining fitting component may be disposed on a ring, band, or other component or insert assembled with the retaining fitting component to be received in an outer circumferential recess of the conduit gripping device when the conduit gripping device (e.g., one or more ferrules) is installed or cartridged in the retaining fitting component. When the fitting is pulled up, axial movement of the conduit gripping device with respect to the projection causes the projection to be plastically deformed into a recess disengaging condition, to permit disassembly of the retaining fitting component from the conduit gripping device.

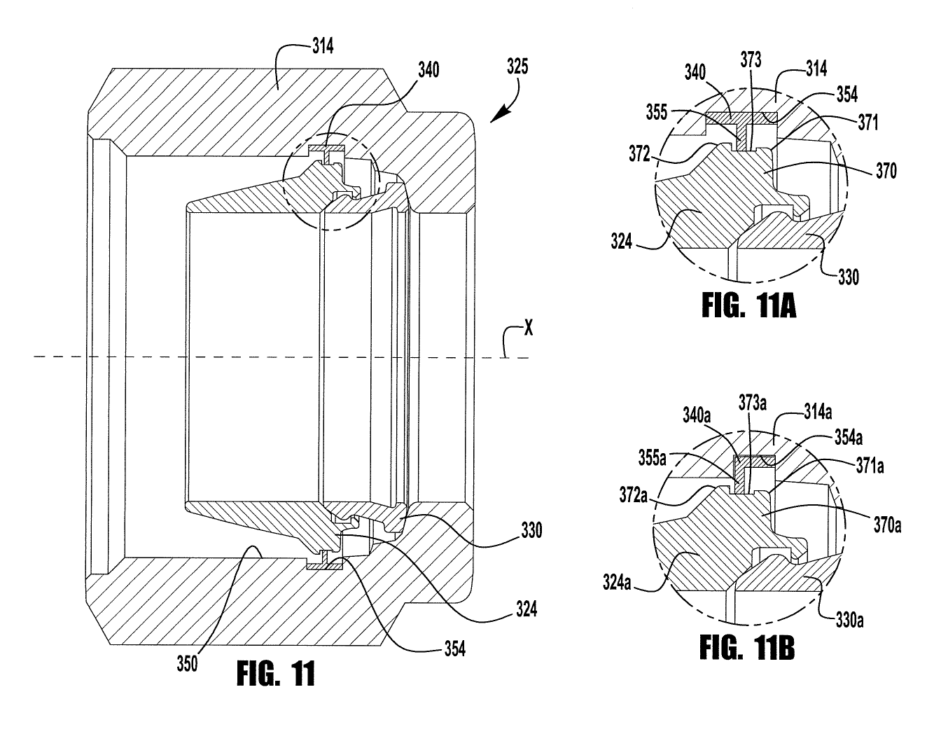

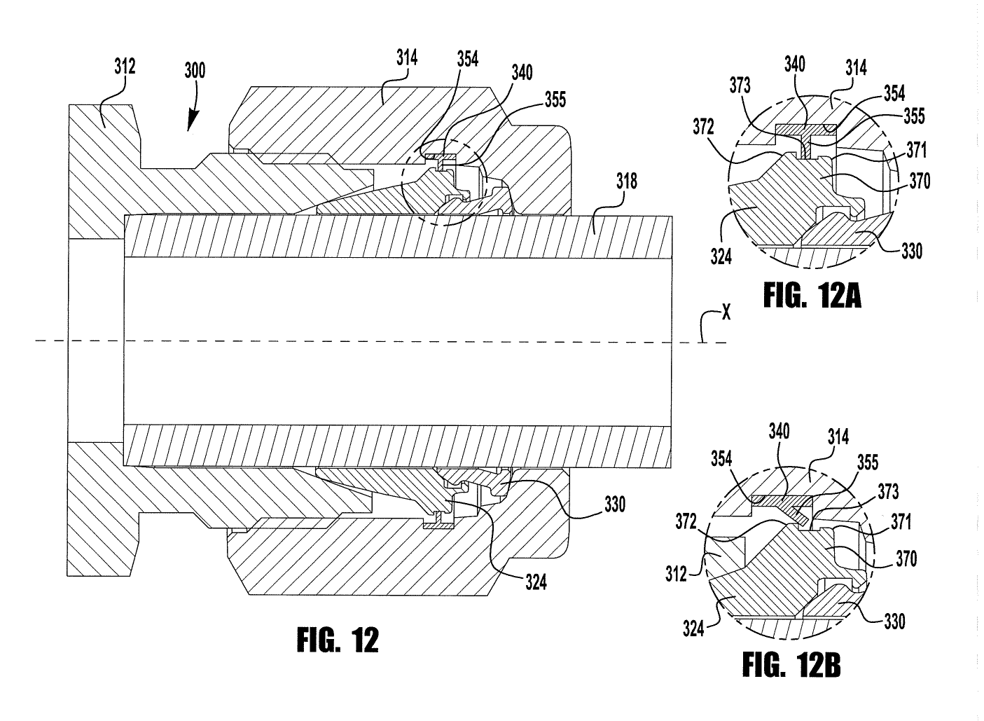

FIGS. 11-12B illustrate an exemplary cartridge nut and ferrule arrangement 325 including a fitting nut 314, a retaining insert 340 and front and rear ferrules 324, 330. The retaining insert 340 is retained in the nut 314, for example, in a circumferential recess 354 in the interior wall 350 of the nut, as shown. The retaining insert may be compressible or otherwise flexible (e.g., a flexible split ring) to facilitate installation in the nut. The insert 340 includes a flexible projection 355 that extends radially inward from the interior wall 350 of the fitting nut 314. When the ferrules 324, 330 are initially installed in the nut 314, an outboard end 371 of a rear flanged portion 370 of the front ferrule 324 engages the projection 355 and elastically bends the projection to receive the projection in an outer circumferential recess 373 in the flanged portion 370, into which the projection elastically snaps for retention of the projection within the recess, and cartridged retention of the ferrules 324, 330 within the fitting nut 314. When the nut 314 is assembled with a fitting body 312, as shown in FIG. 12, and the nut is pulled up on the body, an inboard end 372 of the flanged portion 370 engages the projection 355 and plastically bends the projection partially or fully out of engagement with the circumferential recess 373 (as shown in FIG. 12B), as the flanged portion moves axially outward of the projection. In this plastically deformed condition of the projection, the nut 314 may be disassembled from the ferrules. In some embodiments, the deformed and disengaged projection may slightly radially interfere with the flanged portion 370 while still allowing for nut and ferrule disassembly (e.g., by further minimal outward bending deformation of the projection as the nut 314 is disassembled from the fitting body). The projection 355 need not extend continuously around the interior wall of the nut, but instead may form spaced apart tabs around the interior wall circumference. In other embodiments, the projection may form a continuous ring. As shown, the insert 340 may be substantially T-shaped in cross-section, with the nut recess 354 providing space to facilitate axial outward plastic bending of the projection during pull-up. In other embodiments, the insert may be provided with other cross-sectional shapes, such as, for example, an insert 340a with an L-shaped cross-section, as shown in FIG. 11B (and other components and features similar to the embodiment of FIG. 11 and numbered accordingly). In other embodiments, the projection may be provided as a more flexible (and less plastically deformable) projection, such that the projection is bent axially and radially outward by an outer portion of a ferrule upon ferrule installation, snapping axially and radially inward to axially capture the ferrule, and then bending axially inward and radially outward during disassembly of the nut from the body of the pulled-up fitting.

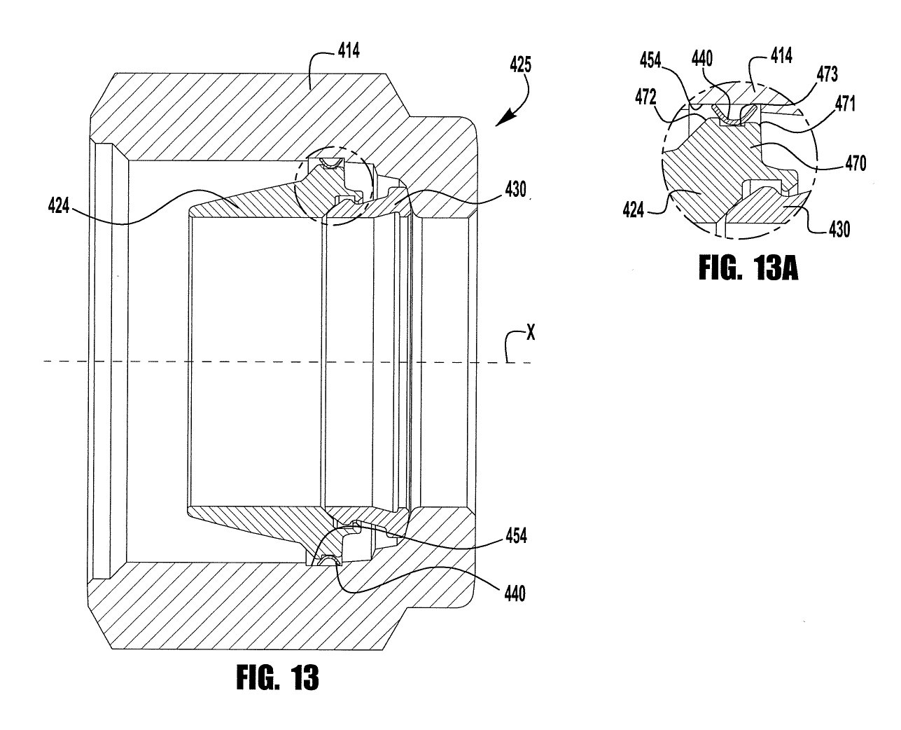

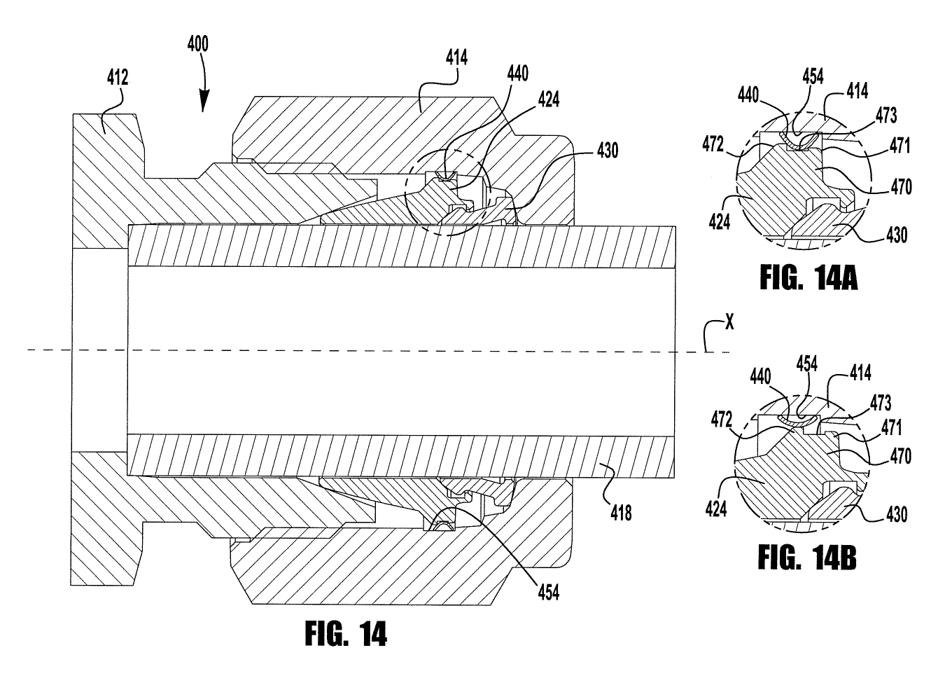

In other embodiments, instead of axially bending, a retaining projection of a cartridge fitting component may be plastically expanded or flattened during pull-up to reduce engagement (e.g., disengage or minimize radial interference) from the conduit gripping device (e.g., single ferrule or front ferrule). FIGS. 13-14B illustrate an exemplary cartridge nut and ferrule arrangement 425 including a fitting nut 414, a retaining insert 440 and front and rear ferrules 424, 430. The retaining insert 440 is retained in the nut 414, for example, in a circumferential recess 454 in the interior wall 450 of the nut, as shown. The retaining insert may be compressible or otherwise flexible (e.g., a flexible split ring) to facilitate installation in the nut. The insert 440 defines a flexible C-shaped projection that extends radially inward from the interior wall 450 of the fitting nut 414. When the ferrules 424, 430 are initially installed in the nut 414, an outboard end 471 of a rear flanged portion 470 of the front ferrule 424 engages the insert 440 and elastically bends or flattens the insert to receive the projection in an outer circumferential recess 473 in the flanged portion 470, into which the insert 440 elastically snaps for retention of the insert within the recess, and cartridged retention of the ferrules 424, 430 within the fitting nut 414. When the nut 414 is assembled with a fitting body 412, as shown in FIG. 14, and the nut is pulled up on the body, an inboard end 472 of the flanged portion 470 engages the projection 455 and plastically flattens or collapses the insert away from engagement with the circumferential recess 473 (as shown in FIG. 14B), as the flanged portion moves axially outward of the projection. As shown, the nut circumferential recess 454 may be provided with an increased axial length to accommodate the flattened condition of the insert 440. In this plastically deformed condition of the projection, the nut 414 may be disassembled from the ferrules. In some embodiments, the deformed and disengaged projection may slightly radially interfere with the flanged portion 470 while still allowing for nut and ferrule disassembly (e.g., by further minimal outward bending deformation of the projection as the nut 414 is disassembled from the fitting body 412). In other embodiments, the insert may be provided with other flattenable or collapsible cross-sectional shapes. In still other embodiments, the projection may be provided as a more flexible (and less plastically deformable) projection, such that the projection is bent expanded, flattened, or collapsed outward by an outer portion of a ferrule upon ferrule installation, snapping radially inward to axially capture the ferrule, and then expanding, flattening, or collapsing outward again during disassembly of the nut from the body of the pulled-up fitting.

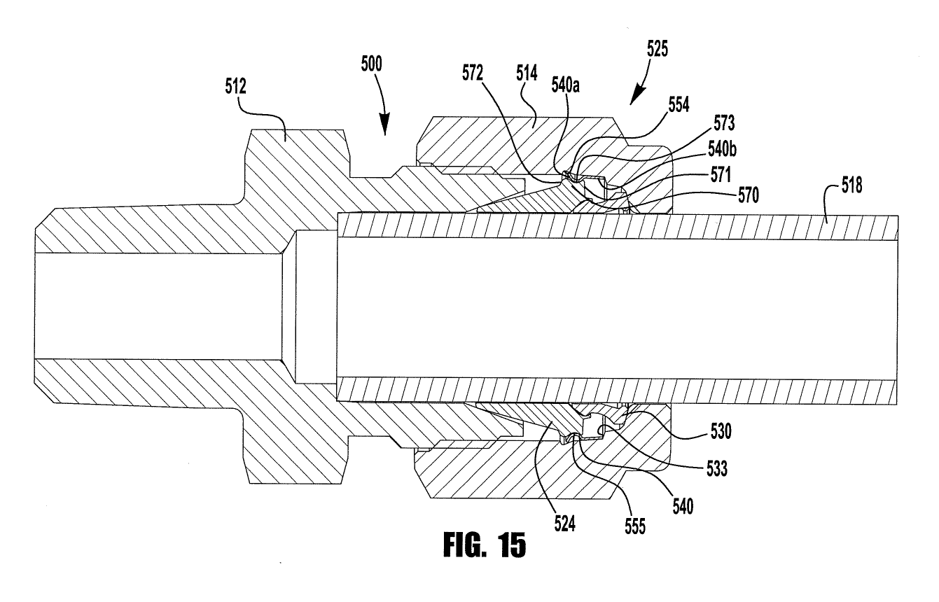

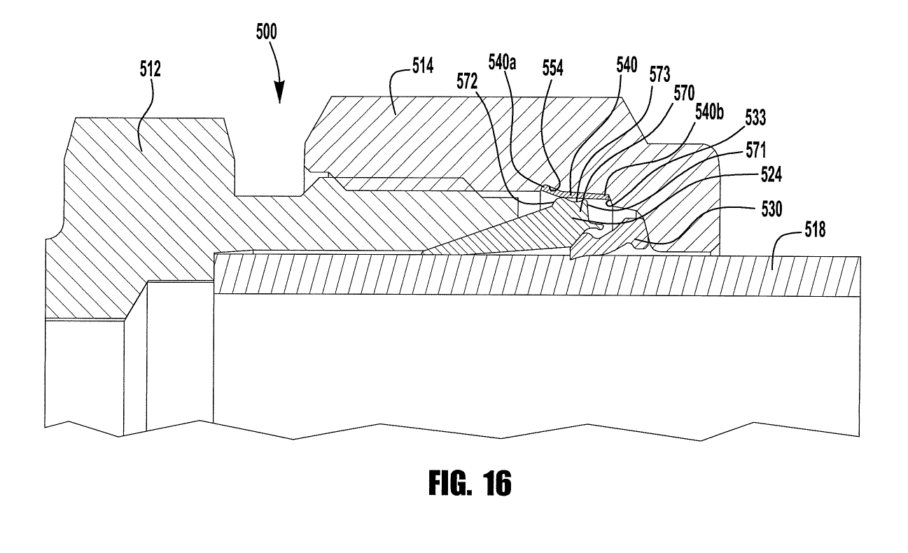

FIGS. 15 and 16 illustrate another exemplary cartridge nut and ferrule arrangement 525 including a fitting nut 514, a retaining insert 540 and front and rear ferrules 524, 530. The retaining insert 540 is retained in the nut 514 by a circumferential recess 554 in the interior wall 550 of the nut that receives an inboard end 540a of the insert 540, with a flat, outboard end 540b of the insert 540 extending to a shoulder 533 in the fitting nut 514 to axially capture the insert. The retaining insert 540 may be loosely received in the fitting nut 514, with the insert's inboard end 540a being flexed into the nut circumferential recess 554 upon installation of the ferrules 524, 530. The insert 540 includes a flexible C-shaped projection 555 that extends radially inward from the interior wall 550 of the fitting nut 514. When the ferrules 524, 530 are initially installed in the nut 514, an outboard end 571 of a rear flanged portion 570 of the front ferrule 524 engages the insert 540 and elastically bends or flattens the projection 555 to receive the projection in an outer circumferential recess 573 in the flanged portion 570, into which the insert 540 elastically snaps for retention of the insert within the recess 573, and cartridged retention of the ferrules 524, 530 within the fitting nut 514. When the nut 514 is assembled with a fitting body 512 pulled up on the body (FIG. 16), an inboard end 572 of the flanged portion 570 engages the projection 555 and plastically flattens or collapses the projection away from engagement with the circumferential recess 573, as the flanged portion moves axially outward of the projection, pushing the inboard end 572 of the insert 540 further into the recess 554. In this plastically deformed condition of the projection, the nut 514 may be disassembled from the ferrules. In some embodiments, the deformed projection may slightly radially interfere with the flanged portion 570 while still allowing for nut and ferrule disassembly (e.g., by further minimal outward bending deformation of the projection as the nut 514 is disassembled from the fitting body 512). In other embodiments, the insert may be provided with other flattenable or collapsible cross-sectional shapes. In still other embodiments, the projection may be provided as a more flexible (and less plastically deformable) projection, such that the projection is expanded, flattened, or collapsed outward by an outer portion of a ferrule upon ferrule installation, snapping radially inward to axially capture the ferrule, and then expanding, flattening, or collapsing outward again during disassembly of the nut from the body of the pulled-up fitting.

In another embodiment, a retaining projection may be defined by a retaining ring that is plastically radially expandable within a circumferential recess of a retaining fitting component, such that upon pull-up, the retaining ring is plastically expanded to be received further into the recess for radial disengagement from the conduit gripping device (e.g., single ferrule or front ferrule). This plastic expansion may result, for example, from an interference fit between the projection and the recess, or one or more tabs or other such spacers within the recess (e.g., integral with the retaining ring or disposed between the retaining ring and the recess) are deformed or broken to permit outward biased expansion of the retaining ring within the recess.

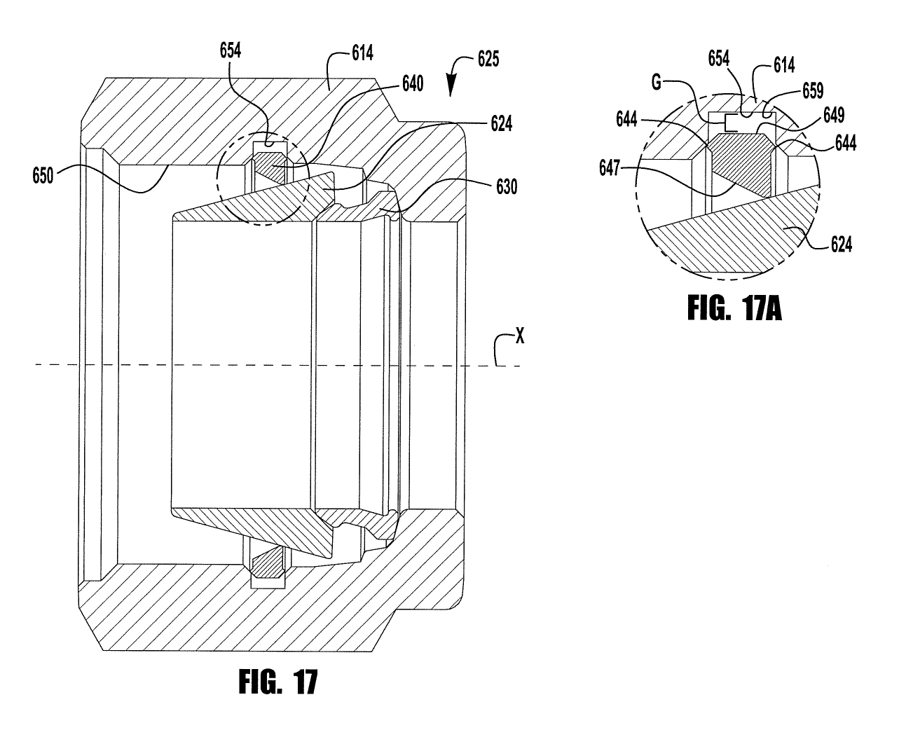

FIGS. 17-18B illustrate an exemplary cartridge nut and ferrule arrangement 625 including a fitting nut 614, a retaining ring or insert 640 and front and rear ferrules 624, 630. The retaining insert 640 is retained within a circumferential recess 654 in the interior wall 650 of the nut 614 to axially capture the insert, with a radial gap G between an outer surface 649 of the insert 640 and an inner surface 659 of the recess 654. The retaining insert 640 may be compressible or otherwise flexible (e.g., a flexible split ring) to facilitate installation in the nut recess. The ferrules 624, 630 may be initially installed in the nut 614 prior to installation of the retaining insert 640. The insert 640 includes a tapered or otherwise contoured driven surface 647 to provide radially outward expansion of the insert 640, further into the circumferential recess 654, when the fitting is pulled up. When the nut 614 is assembled with a fitting body 612 (FIG. 18) and is pulled up on the body, an end portion 660 of the fitting body 612 engages the contoured driven surface 647 of the insert 640 to plastically expand the insert further into the recess 654 and away from engagement with the front ferrule 624 (as shown in FIG. 18B). (In other embodiments, the fitting body end portion may additionally or alternatively be tapered or otherwise contoured to facilitate radial expansion of the insert during pull-up.) Compressible or collapsible projections 644 may be provided on the insert 640 to provide an interference fit between the insert 640 and the recess 654 to retain the insert 640 in the expanded condition. In the plastically expanded condition of the insert 640, the nut 614 may be disassembled from the ferrules 624, 630. While the plastically expanded insert 640 may be fully radially disengaged from the front ferrule, in some embodiments, the radially inner portion of the expanded insert may slightly radially interfere with the outer portion of the front ferrule while still allowing for nut and ferrule disassembly (e.g., by further minimal outward bending deformation of the projection as the nut 614 is disassembled from the fitting body 612). In other embodiments, the insert may be configured to be radially expanded by engagement with a portion of the ferrule (e.g., a flanged rear portion of the ferrule having a recess for receiving the unexpanded insert, similar to several of the embodiments described above). In still other embodiments, the insert may be provided as a more flexible (and less plastically deformable) component, such that the insert is expanded outward by an outer portion of a ferrule upon ferrule installation, snapping radially inward to axially capture the ferrule, and then expanding outward again during disassembly of the nut from the body of the pulled-up fitting.

In other embodiments, a retaining ring may be assembled with a conduit gripping device (e.g., a single ferrule or front ferrule), either before or after the conduit gripping device is installed in a retaining fitting component. The retaining ring may be expanded onto the conduit gripping device and seated between a circumferential recess in the interior wall of the retaining fitting component and an outer surface of the conduit gripping device. When the fitting is pulled up, a portion of a mating fitting component (e.g., fitting body) engages the retaining ring and axially moves the retaining ring into axial alignment with a circumferential recess in the conduit gripping device, allowing the retaining ring to radially retract into the gripping device recess to provide radial clearance between the retaining ring and the interior wall of the retaining fitting component, to permit disassembly of the retaining fitting component from the conduit gripping device.

FIGS. 19, 19A, and 19B illustrate an exemplary cartridge nut and ferrule arrangement 725 including a fitting nut 714, a retaining ring 740 and front and rear ferrules 724, 730. The retaining ring 740 is radially expanded (i.e., inwardly biased) and retained on a first recess 753 of the front ferrule 724 and is seated in a circumferential recess 754 in the interior wall 750 of the fitting nut 714. The retaining ring 740 may be secured around the front ferrule first recess 753 prior to installation of the ferrules in the nut, or alternatively, the ferrules 724, 730 may be first installed in the fitting nut, and the retaining ring subsequently inserted into the nut and seated between the nut recess 754 and the front ferrule first recess 753. When the nut 714 is pulled up on the fitting body 712, an end portion 760 of the fitting body engages the retaining ring 740 and axially pushes the retaining ring into alignment with a second recess 757 of the front ferrule 724, allowing the retaining ring 740 to retract away from engagement with the nut recess 754. In this retracted condition of the retaining ring, the nut 714 may be disassembled from the ferrules 724, 730. While the retracted retaining ring may be fully radially disengaged from the nut, in some embodiments, the retracted retaining ring may slightly radially interfere with the interior wall of the nut while still allowing for nut and ferrule disassembly (e.g., by further minimal inward retraction of the retaining ring due to engagement with the nut interior wall).

As shown in the corresponding Figures for several of the embodiments described above (see, e.g., FIGS. 7-8A, 11-12A, 13-14A, 15 and 16), the front and rear ferrules may themselves include features for cartridging together, either prior to or synchronous with assembly with the fitting nut, similar to the cartridging ferrule embodiments described in co-owned U.S. Pat. No. 9,267,627, titled FERRULE ASSEMBLY FOR CONDUIT FITTING (the “'627 Patent”), and co-pending U.S. Patent Application Pub. No. 2015/0323110, filed on May 8, 2015 for CONDUIT FITTING WITH COMPONENTS ADAPTED FOR FACILITATING ASSEMBLY (the “'110 Application”), the entire disclosure of which is incorporated herein by reference, and in the above incorporated '810 Patent and '288 and '048 Applications. This cartridging of the ferrules (when combined with cartridging of the front ferrule with the nut, as described above and in the '810 Patent and '288 and '048 Applications) may allow for extraction of the cartridged ferrule subassembly from a cartridging nut in some embodiments, or for ease of proper installation of the cartridged ferrules into a nut for cartridging with the nut. In other embodiments, the cartridging of the front ferrule with the rear ferrule may allow for nut retention of both ferrules by cartridging the nut with the rear ferrule, as shown and described, for example, in the embodiments of FIGS. 43-49 of the '810 Patent. The present application contemplates and describes other arrangements for cartridging a rear ferrule with a fitting nut.

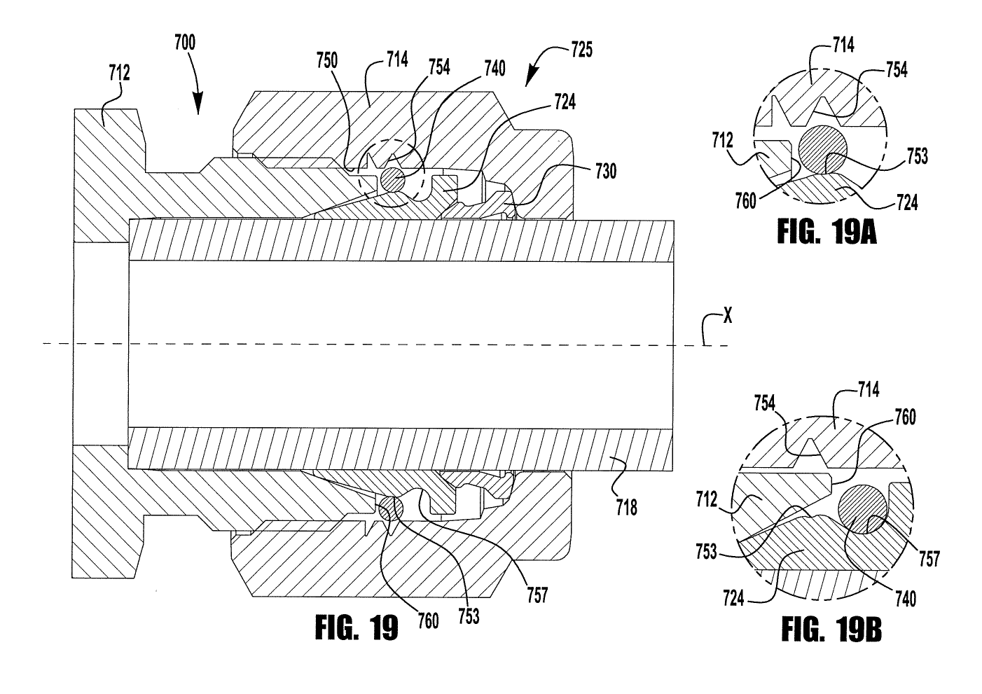

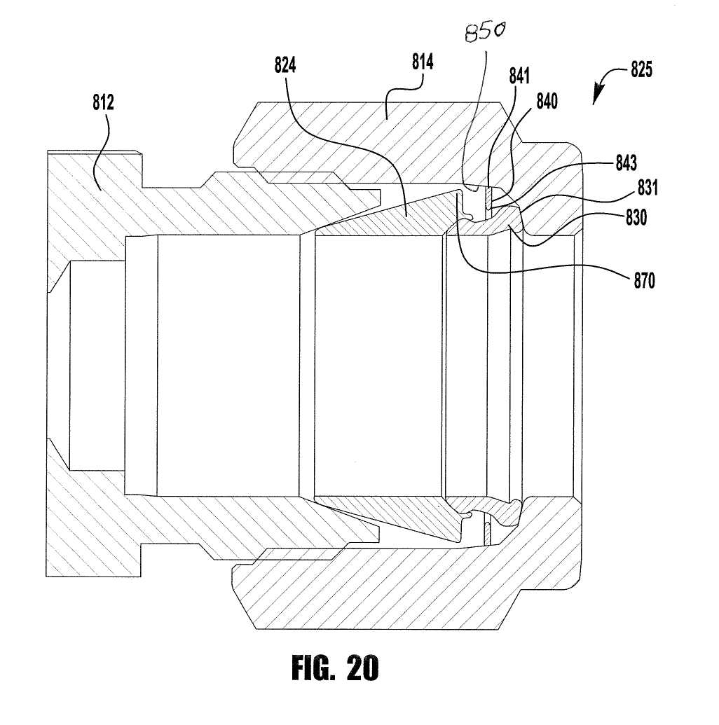

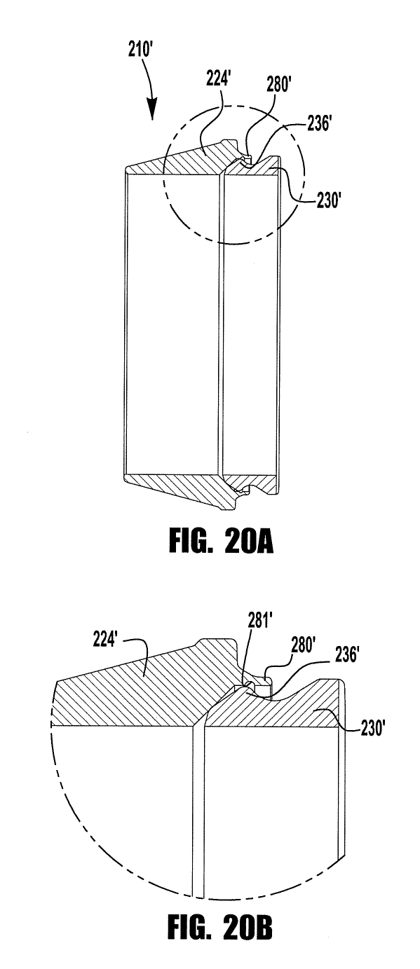

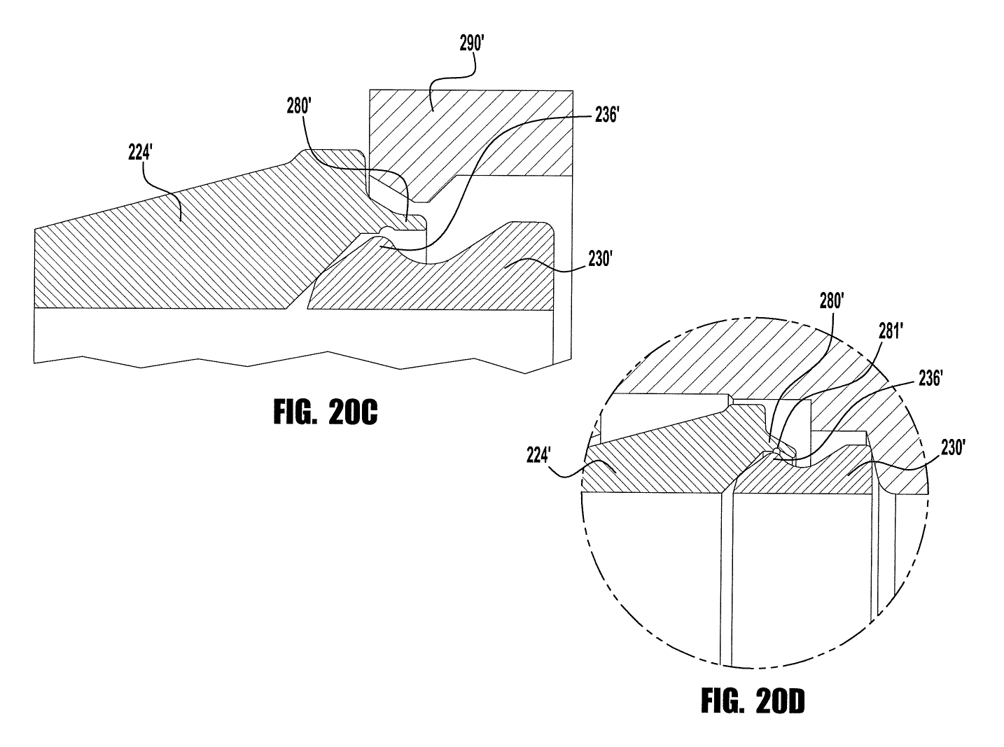

In the above incorporated '627 Patent and '110 Application, and as shown in several of the embodiments herein, the front ferrule includes a retaining extension that is generally annular and extends axially from a back wall or outboard radial surface of the front ferrule. The extension acts as a clip or tang that snaps over the crown of the back ferrule when the ferrules are axially pressed together. In other embodiments, the front ferrule extension may be plastically deformed or crimped radially inward over an enlarged front portion (e.g., a crown portion) of the rear ferrule, for example, using a clamping tool or other such device. FIGS. 20A, 20B, 20C, and 20D illustrate an exemplary front and rear ferrule arrangement 210a including a front ferrule 224a having a rear extension 280a and a rear ferrule 230a having an enlarged front portion or crown portion 236a. The extension 280a may include a narrowed portion 281a to facilitate bending or crimping. The rear extension of the front ferrule 224a is compressed (e.g., using a clamping tool 290a, as shown in FIG. 20B) over the enlarged front portion of the rear ferrule to provide interlocking or cartridging interengagement of the front and rear ferrules. When the front and rear ferrule are installed in a fitting and the fitting is pulled up, radially outward expansion of the front ferrule rear end and radially inward compression of the rear ferrule front end are sufficient to disengage the enlarged front portion of the rear ferrule from the crimped extension of the front ferrule.

According to an exemplary aspect of the present application, a rear ferrule retaining member may be configured to extend radially inward between the front and rear ferrule in a retaining condition. The rear ferrule retaining member may be deformable to release the rear ferrule from the nut, for example, by manual unthreading or loosening of the nut from the body of a pulled-up fitting. FIG. 20 illustrates an exemplary cartridge nut and cartridged front and rear ferrule arrangement 825, loosely assembled with a fitting body 812, the arrangement 825 including a fitting nut 814, a retaining member 840 and front and rear ferrules 824, 830. The retaining member 840 includes an outer radial portion 841 secured to the interior wall 850 of the nut 814 to axially capture the insert, and an inner radial portion 843 that extends radially inward between an outer rear portion 870 of the front ferrule 824 and a rear portion 831 of the rear ferrule 830. The retaining member 840 may be compressible or otherwise flexible (e.g., a flexible ring shaped member, washer or split ring) to facilitate installation in the nut 814. The ferrules 824, 830 may be installed in the nut 814 by pushing the rear end portion 831 of the rear ferrule 830 against the inner radial portion 843 of the retaining member 840 to elastically radially expand the inner radial portion 843 of the insert to receive the rear ferrule therethrough. The ferrules 824, 830 may be pre-cartridged with each other before installation in the nut 814 (as described above and in the above incorporated '627 Patent and '110 Application), or the front ferrule 824 may be cartridged with the rear ferrule 830 after the rear ferrule has been installed in the nut. In another arrangement, the un-cartridged rear ferrule 830 may be installed in the nut 814, followed by installation of the insert 840, with the front ferrule 824 then installed into the nut 814 and cartridged with the rear ferrule 830, such that the rear ferrule does not need to be forced past the insert.

The outer radial portion 841 of the retaining member 840 may be secured in a groove or recess, or may be press fit, for example, against a tapered interior surface of the nut, as shown in FIG. 20. The retaining member 840 may comprise a variety of suitable components, including, for example, a press fit ring, one or more pins or tabs, or other such deformable components, including, for example, one or more inserts similar to the front ferrule retaining inserts of FIGS. 1-18. As shown, the retaining member may not be deformed during fitting pull-up, instead being flexible enough to permit axial inward and radial outward bending of the outer radial portion 841 during unthreading or loosening of the nut 814 from the fitting body 812 to permit axial separation of the nut 814 from the rear ferrule 830.

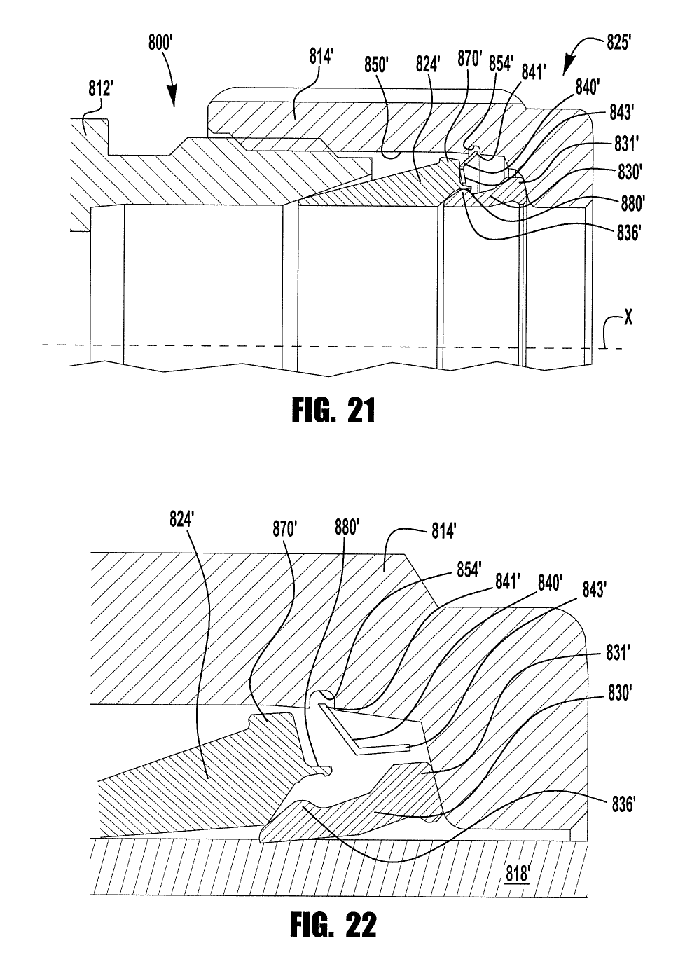

According to another exemplary aspect of the present application, a rear ferrule retaining member may be deformable to release the rear ferrule from the nut as a result of pull-up of the nut on a fitting body during installation of the fitting on a conduit. FIGS. 21 and 22 illustrate an exemplary cartridge nut and cartridged front and rear ferrule arrangement 825′ including a fitting nut 814′, a retaining ring or insert 840′ and front and rear ferrules 824′, 830′. The retaining insert 840′ includes an outer radial portion 841′ retained within a circumferential recess 854′ in the interior wall 850′ of the nut 814′ to axially capture the insert, and an inner radial portion 843′ that extends radially inward between a rear flange portion 870′ of the front ferrule 824′ and a rear portion 831′ of the rear ferrule 830′. The retaining insert may be compressible or otherwise flexible (e.g., a flexible split ring) to facilitate installation in the nut 814′. The ferrules 824′, 830′ may be installed in the nut 814′ by pushing the rear end portion 831′ of the rear ferrule 830′ against the insert 840′ to elastically radially expand the inner radial portion 843′ of the insert to receive the rear ferrule therethrough. The ferrules 824′, 830′ may be pre-cartridged with each other before installation in the nut 814′ (as described above and in the above incorporated '627 Patent and '110 Application), or the front ferrule 824′ may be cartridged with the rear ferrule 830′ after the rear ferrule has been installed in the nut. In another arrangement, the un-cartridged rear ferrule 830′ may be installed in the nut 814′, followed by installation of the insert 840′, with the front ferrule 824′ then installed into the nut 814′ and cartridged with the rear ferrule 830′, such that the rear ferrule does not need to be forced past the insert.

When the nut 814′ is assembled with a fitting body 812′ and is pulled up on the body (FIG. 22), the rear flange portion 870′ of the front ferrule 824′ engages the inner radial portion 843′ of the insert 840′ to flex, bend, or invert the insert 840′ to move the inner radial portion 843′ away from radial alignment with the rear end portion 831′ of the rear ferrule 830′. While many different types of flexing or inverting inserts may be utilized, in the illustrated embodiment, the insert 840′ is a Belleville type spring washer configured to be inverted from the retaining condition to the releasing condition when an outward axial force is applied to the inner radial portion. While the inverted insert 840′ may be fully radially disengaged from the rear ferrule 830′, in some embodiments, the radially inner portion of the inverted insert may slightly radially interfere with the rear portion of the rear ferrule while still allowing for nut and ferrule disassembly (e.g., by further minimal outward bending deformation of the inner radial portion of the insert as the nut is disassembled from the fitting body).

According to another exemplary aspect of the present application, a rear ferrule retaining ring may be configured to engage a rear end portion of the rear ferrule in a retaining condition. When the fitting is pulled up, the resulting radial outward expansion of the rear end portion of the rear ferrule plastically deforms the retaining ring into a radially outward, ferrule releasing condition.

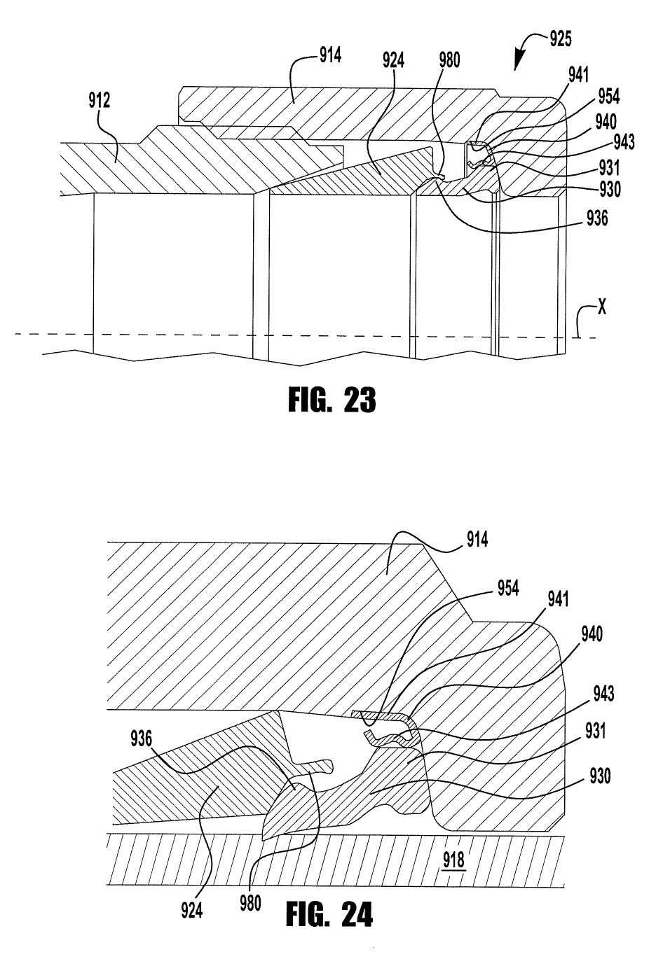

FIGS. 23 and 24 illustrate an exemplary cartridge nut and cartridged front and rear ferrule arrangement 925 including a fitting nut 914, a retaining ring or insert 940 and front and rear ferrules 924, 930. The retaining insert 940 includes an outer radial portion 941 retained within a circumferential recess 954 in the interior wall 950 of the nut 914 to axially capture the insert, and an inner radial portion 943 that extends radially inward and is shaped to engage an upper surface of a rear portion 931 of the rear ferrule 930. The retaining insert 940 may be compressible or otherwise flexible (e.g., a flexible split ring) to facilitate installation in the nut. The ferrules 924, 930 may be installed in the nut 914 by pushing the rear end portion 931 of the rear ferrule 930 against the inner radial portion 943 of the insert 940 to elastically radially expand the inner radial portion 943 of the insert to receive the rear portion 931 therethrough. The ferrules 924, 930 may be pre-cartridged with each other before installation in the nut 914 (as described above and in the above incorporated '627 Patent and '110 Application), or the front ferrule 924 may be cartridged with the rear ferrule 930 after the rear ferrule has been installed in the nut. When the nut 914 is assembled with a fitting body 912 and is pulled up on the body (FIG. 24), the rear portion 931 of the rear ferrule 930 expands radially outward to plastically expand the inner radial portion 943 of the insert 940 away from interlocking or interfering engagement with the rear portion 931 of the rear ferrule 930, thus allowing subsequent disassembly of the nut from the ferrules of the pulled up fitting. While the expanded insert may be fully radially disengaged from the rear ferrule, in some embodiments, the radially inner portion of the deformed insert may slightly radially interfere with the rear portion of the rear ferrule while still allowing for nut and ferrule disassembly (e.g., by further minimal outward bending deformation of the inner radial portion of the insert as the nut is disassembled from the fitting body).

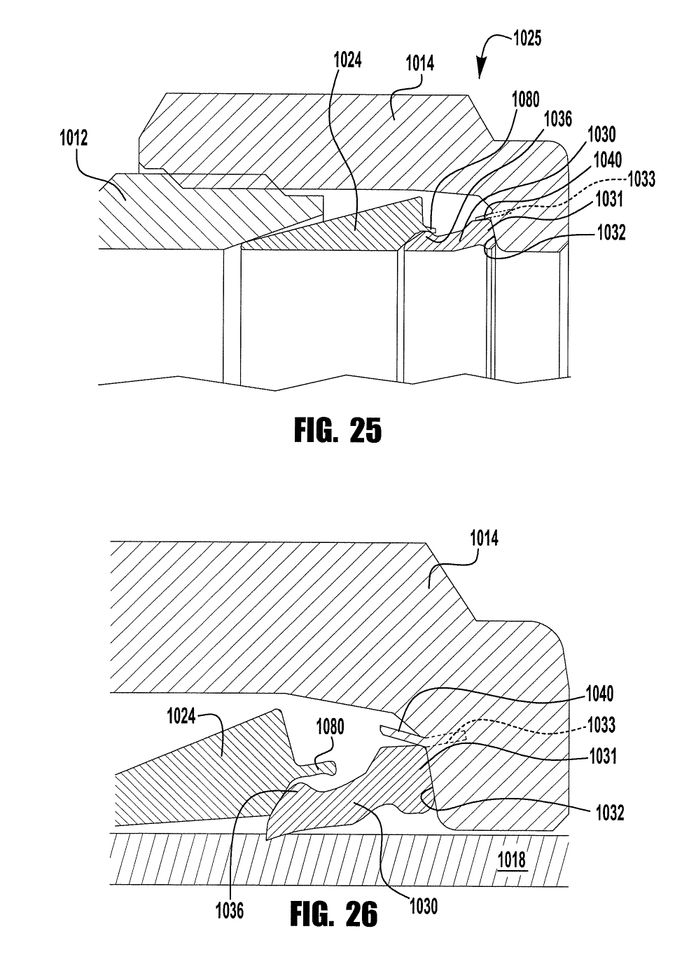

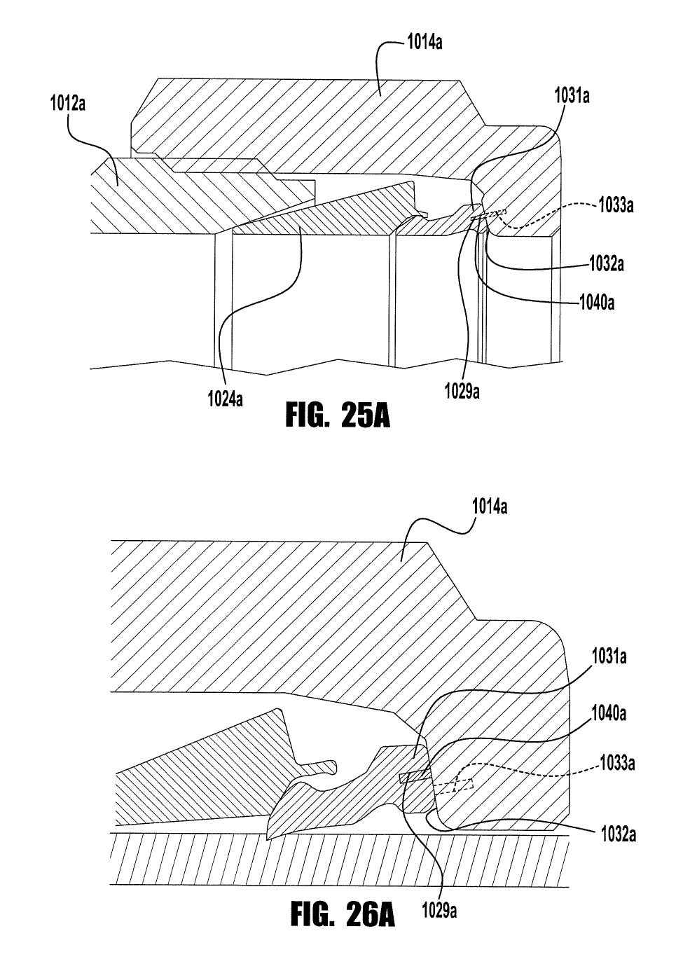

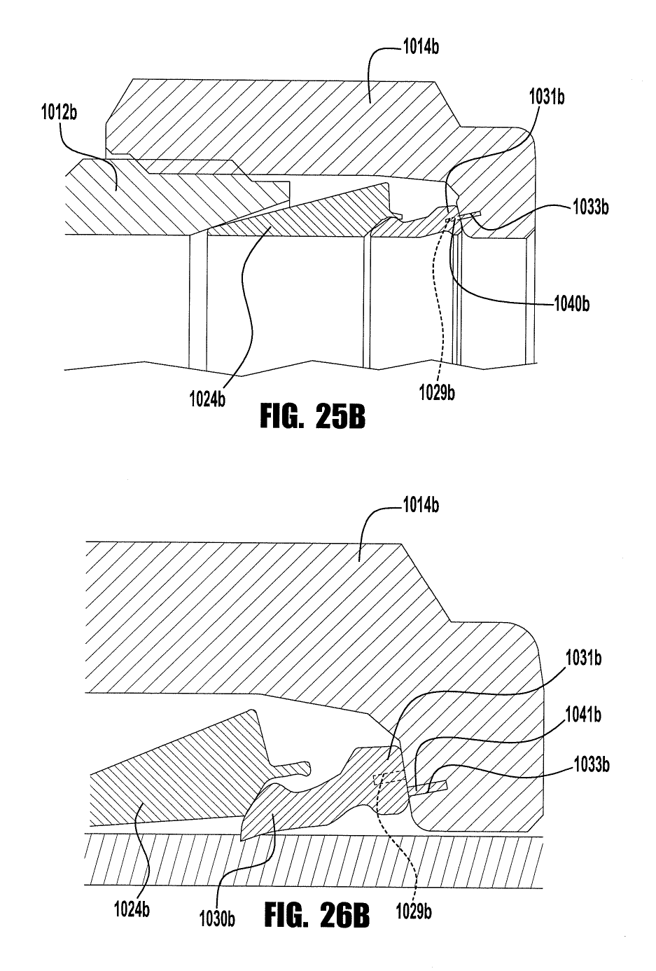

In another embodiment, a fitting nut may be provided with a retaining extension (e.g., ring, or one or more pins or tabs) configured to engage a rear end portion of the rear ferrule in a retaining condition, and plastically deforming to release the rear ferrule upon pull-up. FIGS. 25 and 26 illustrate an exemplary cartridge nut and cartridged front and rear ferrule arrangement 1025 including a fitting nut 1014 and front and rear ferrules 1024, 1030. The nut 1014 includes a retaining extension 1040 extending axially inward from the nut drive surface 1032 and is oriented to engage an upper surface of a rear portion 1031 of the rear ferrule 1030. While the retaining extension 1040 may be machined integrally with the nut 1014, in another embodiment, the retaining extension 1040 may be staked into a groove (shown in phantom at 1033) in the drive surface 1032 of the nut 1014, which may provide for ease of manufacture or selection of retaining ring materials having desirable deformation properties.

The retaining extension 1040 may be flexible, such that the rear ferrule 1030 may be installed in the nut 1014 by pushing the rear end portion 1031 of the rear ferrule 1030 against the retaining extension 1040 to elastically radially expand the retaining extension to receive the rear portion 1031 therethrough. Alternatively, the retaining extension 1040 may be crimped or staked (e.g., by a tool inserted into the nut) into retaining engagement with the rear ferrule rear portion 1031 after the rear ferrule 1030 has been loosely installed in the nut 1030. The ferrules 1024, 1030 may be pre-cartridged with each other before installation in the nut 1014 (as described above and in the above incorporated '627 Patent and '110 Application), or the front ferrule 1024 may be cartridged with the rear ferrule 1030 after the rear ferrule has been installed in the nut. When the nut 1014 is assembled with a fitting body 1012 and is pulled up on the body (FIG. 26), the rear portion 1031 of the rear ferrule 1030 expands radially outward to plastically expand the retaining extension 1040 away from interlocking or interfering engagement with the rear portion 1031 of the rear ferrule 1030, thus allowing subsequent disassembly of the nut from the ferrules of the pulled up fitting. While the expanded retaining extension may be fully radially disengaged from the rear ferrule, in some embodiments, the deformed retaining extension may slightly radially interfere with the rear portion of the rear ferrule while still allowing for nut and ferrule disassembly (e.g., by further minimal outward bending deformation of the retaining extension as the nut is disassembled from the fitting body).

In another embodiment, a fitting nut may be provided with a retaining extension (e.g., ring, or one or more pins or tabs) configured to be received in a recess in the rear portion of the rear ferrule when the rear ferrule is installed in nut, with the retaining extension shearing to separate the rear ferrule from the nut when the nut is assembled with a fitting body and is pulled up on the body. FIGS. 25A and 26A illustrate an exemplary cartridge nut and cartridged front and rear ferrule arrangement 1025a including a fitting nut 1014a and front and rear ferrules 1024a, 1030a. The nut 1014a includes a retaining extension 1040a extending axially inward from the nut drive surface 1032a and is oriented to be received in a recess 1029a in the rear portion 1031a of the rear ferrule 1030a. A press fit or interference fit may be provided between the retaining extension 1040a and the recess 1029a to provide secure cartridging retention of the rear ferrule 1030a. While the retaining extension 1040a may be machined integrally with the nut 1014a, in another embodiment, the retaining extension 1040a may be staked into a groove (shown in phantom at 1033a) in the drive surface 1032a of the nut 1014a, which may provide for ease of manufacture or selection of retaining ring materials having desirable deformation properties. When the nut 1014a is assembled with a fitting body 1012a and is pulled up on the body (FIG. 26A), the rear portion 1031a of the rear ferrule 1030a expands radially outward, shearing the radial extension 1040a between the rear ferrule rear portion 1031a and the nut drive surface 1032a, thus allowing subsequent disassembly of the nut 1014a from the ferrules 1024a, 1030a of the pulled up fitting. Alternatively, where the retaining extension 1040a is formed from one or more discrete pins or tabs, relative rotation of the nut 1014a with respect to the rear ferrule 1030a during pull-up, and the resulting torsion forces, may cause the extension 1040a to shear between the rear ferrule rear portion 1031a and the nut drive surface 1032a, thus allowing subsequent disassembly of the nut 1014a from the ferrules 1024a, 1030a of the pulled up fitting.

In another embodiment, a rear ferrule may be provided with a retaining extension (e.g., ring, or one or more pins or tabs) configured to be received in a recess in the drive surface of the fitting nut when the rear ferrule is installed in nut, with the retaining extension shearing to separate the rear ferrule from the nut when the nut is assembled with a fitting body and is pulled up on the body. FIGS. 25B and 26B illustrate an exemplary cartridge nut and cartridged front and rear ferrule arrangement 1025b including a fitting nut 1014b and front and rear ferrules 1024b, 1030b. The rear ferrule 1030b includes a retaining extension 1040b extending axially outward from the rear ferrule rear portion 1031b and is oriented to be received in a recess 1033b in the nut drive surface 1032b. A press fit or interference fit may be provided between the retaining extension 1040b and the recess 1033b to provide secure cartridging retention of the rear ferrule 1030b. While the retaining extension 1040b may be machined integrally with the rear ferrule 1030b, in another embodiment, the retaining extension 1040b may be staked into a groove (shown in phantom at 1029b) in the rear ferrule rear portion 1031b, which may provide for ease of manufacture or selection of retaining ring materials having desirable deformation properties. When the nut 1014b is assembled with a fitting body 1012b and is pulled up on the body (FIG. 26B), the rear portion 1031b of the rear ferrule 1030b expands radially outward, shearing the radial extension 1040b between the rear ferrule rear portion 1031b and the nut drive surface 1032b, thus allowing subsequent disassembly of the nut 1014b from the ferrules 1024b, 1030b of the pulled up fitting. Alternatively, where the retaining extension 1040b is formed from one or more discrete pins or tabs, relative rotation of the nut 1014b with respect to the rear ferrule 1030b during pull-up, and the resulting torsion forces, may cause the extension 1040b to shear between the rear ferrule rear portion 1031b and the nut drive surface 1032b, thus allowing subsequent disassembly of the nut 1014b from the ferrules 1024b, 1030b of the pulled up fitting.

In other embodiments, a retaining member secured with the outboard end of the fitting nut may interlock with or otherwise engage an inner notched portion of the rear ferrule (or with a single ferrule in a single ferrule fitting design). When the fitting is pulled up, the resulting radial outward expansion of the rear end portion of the rear ferrule causes the inner notched portion to disengage from the retaining member, thus allowing the nut to be disassembled from the rear ferrule.

In an exemplary embodiment, a rear ferrule retaining member is formed as a ring sized to be compressibly received through the outboard opening in the nut, with a first end hook portion engaging the rear ferrule inner notch, and a second end hook portion engaging an internal recess in the nut outboard end. FIGS. 27 and 28 illustrate an exemplary cartridge nut and cartridged front and rear ferrule arrangement 1125 including a fitting nut 1114, a retaining ring or insert 1140 and front and rear ferrules 1124, 1130. The retaining insert 1140 includes an outer first end hook portion 1141 sized and oriented to be received in the inner notch portion 1139a of the rear ferrule 1130, and a second end hook portion 1143 sized and oriented to be received in an internal recess 1133 in the outboard end of the nut 1114. The retaining insert 1140 may be compressible or otherwise flexible (e.g., a flexible split ring) to facilitate installation in the nut. Additionally or alternatively, the insert may be installed into the nut and ferrule subassembly as a cylindrical or tubular ring with the ends crimped or staked radially outward to form the first and second end hook portions. The ferrules 1124, 1130 may be installed in the nut 1114 by pushing the rear end portion 1131 of the rear ferrule 1130 against the first end hook portion 1141 of the insert 1140 to elastically radially compress the first end hook portion 1141 of the insert to receive the first end hook portion in the notch. The ferrules 1124, 1130 may be pre-cartridged with each other before installation in the nut 1114 (as described above and in the above incorporated '627 Patent and '110 Application), or the front ferrule 1124 may be cartridged with the rear ferrule 1130 after the rear ferrule has been installed in the nut. When the nut 1114 is assembled with a fitting body 1112 and is pulled up on the body (FIG. 28), the rear portion 1131 of the rear ferrule 1130 expands radially outward and disengages from the first end hook portion 1141, thus allowing subsequent disassembly of the nut 1114 from the ferrules 1124, 1130 of the pulled up fitting. In another exemplary embodiment (not shown), the retaining ring may be integral with the nut, for example, machined as an integral extension or made integral, for example, by welding, brazing, adhesive, or interference fit snap-in-place structure.

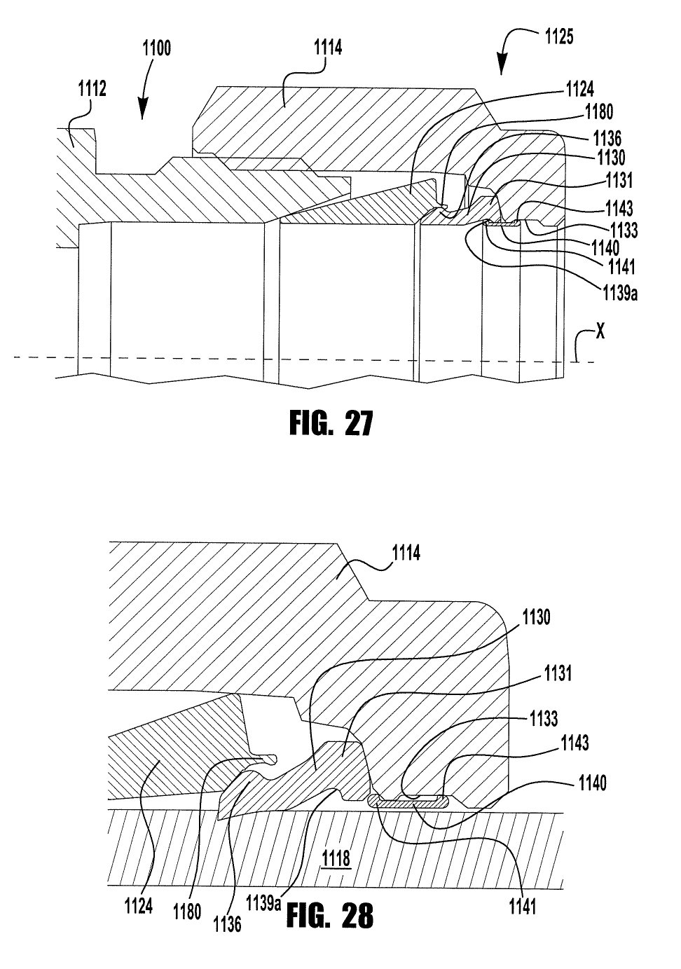

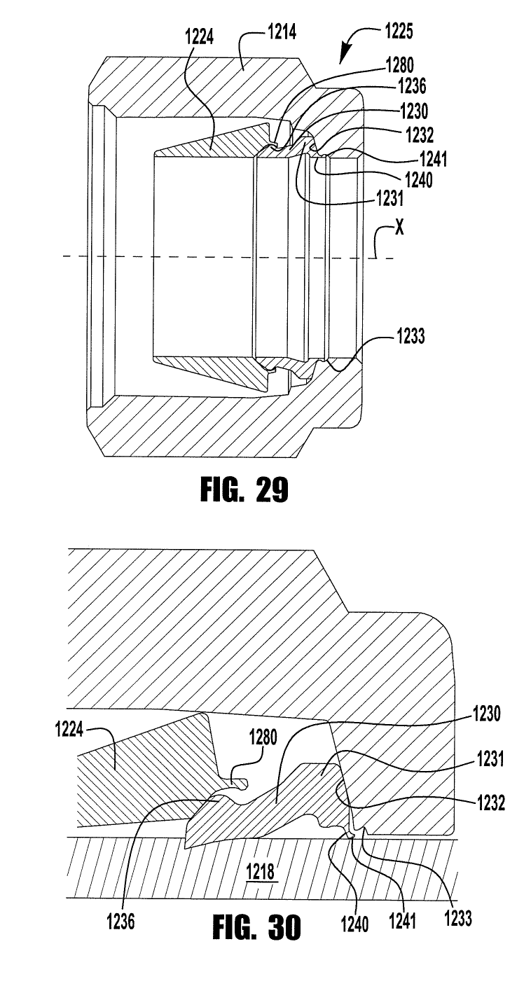

In an exemplary embodiment, a rear ferrule retaining ring is formed on the rear ferrule as an integral hook extension configured to engage an internal recess in the nut outboard end. FIGS. 29 and 30 illustrate an exemplary cartridge nut and cartridged front and rear ferrule arrangement 1225 including a fitting nut 1214 and front and rear ferrules 1224, 1230. The rear ferrule 1230 includes a retaining extension 1240 having a hook portion 1241 sized and oriented to be received in an internal recess 1233 in the outboard end of the nut 1214. The retaining extension 1240 may be compressible or otherwise flexible to facilitate a snap-together engagement with the nut recess 1233. The ferrules 1224, 1230 may be installed in the nut 1214 by pushing the retaining extension 1240 of the rear ferrule 1230 against the nut drive surface 1232 to elastically radially compress the retaining extension 1240 to be received in the nut recess 1233. The ferrules 1224, 1230 may be pre-cartridged with each other before installation in the nut 1214 (as described above and in the above incorporated '627 Patent and '110 Application), or the front ferrule 1224 may be cartridged with the rear ferrule 1230 after the rear ferrule has been installed in the nut. When the nut 1214 is assembled with a fitting body (not shown) and is pulled up on the body (FIG. 30), the rear portion 1231 of the rear ferrule 1230 expands radially outward and pulls the retaining extension 1240 out of engagement with the nut recess 1233, thus allowing subsequent disassembly of the nut 1214 from the ferrules 1224, 1230 of the pulled up fitting.

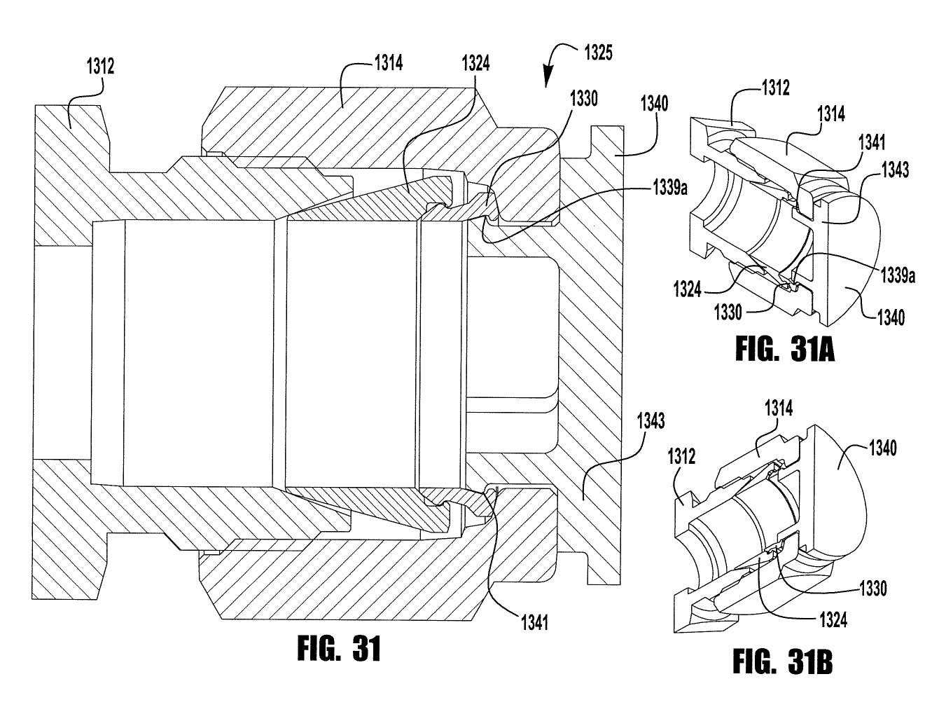

In another exemplary embodiment, a rear ferrule (or single ferrule, in a single ferrule fitting design) retaining member is provided as a removable component intended to be removed after the nut subassembly is loosely assembled with a fitting body, and before the conduit is installed in the nut and body. In one such embodiment, the removable retaining member may form a dust cover or other such cover member to keep dust or other contaminants out of the internal surfaces of the cartridge subassembly, or out of a finger tight fitting assembly in storage prior to installation and pull-up on a conduit. FIGS. 31, 31A, and 31B illustrate an exemplary cartridge nut and cartridged front and rear ferrule arrangement 1325 including a fitting nut 1314, a retaining member 1340 and front and rear ferrules 1324, 1330. The retaining member 1340 includes a first end hook portion 1341 sized and oriented to be received in the inner notch portion 1339a of the rear ferrule 1330, and a second end cap portion 1343 that abuts the outboard end of the nut 1314. The retaining insert 1340 may be compressible or otherwise flexible (e.g., formed from a plastic or elastomeric material) to facilitate installation in and extraction from the nut 1314. The ferrules 1324, 1330 are loosely installed in the nut 1314, and then the hook portion 1341 of the retaining member 1340 is inserted into the outboard end of the to receive the first end hook portion in the notch 1339a. After the nut has been loosely assembled with a fitting body 1312 (such that the ferrules 1324, 1330 are retained between the fitting body 1312 and the nut 1314, the retaining member 1340 may be removed from the nut (e.g., by axially pulling the cap portion 1343) to allow for conduit installation.

According to another aspect of the present application, one or more ferrules may be cartridged with each other and/or with a fitting nut using an adhesive, wax, polymer, thixotropic substance, tape, or other releasable material applied to adjacent surfaces of the fitting components. As one example, an adhesive securing together a retaining fitting component (e.g., nut) and a ferrule, and/or a front ferrule and a rear ferrule may be provided with an encapsulated solvent (e.g., a microencapsulated solvent), such that when the adhered surfaces are exposed to assembly related forces (e.g., compressive, tensile, and/or shear forces), the adhesive is exposed to the solvent to dissolve the adhesive. As another example, a releasable material (e.g., an adhesive or polymer) disposed in a recess of a fitting component surface (e.g., ferrule outer surface, nut interior surface) may be plastically compressible, such that radial movement of the adjacent surfaces between which the releasable material is disposed causes the releasable material to flatten and/or detach from either or both of the adjacent surfaces. As still another example, a tape member or adhesive tab, may be bent, folded or otherwise positioned to span across adjacent surfaces of two or more fitting components (e.g., a ferrule and a nut, or a front ferrule and a back ferrule, with the adhesive tab shearing upon fitting pull-up (e.g., due to torsion, radial, and/or axial forces between the adjacent fitting components). As yet another example, a releasable material may include a compressible or frictional material selected to resist axial separation by providing for press fit, interference fit, or friction fit retention between a nut and ferrule and/or between a front ferrule and a back ferrule. The releasable material may be configured to release upon pull-up, or may be configured to maintain detent-type retention, allowing for disengagement of the nut from the ferrules when the nut is unthreaded or loosened from the pulled up fitting, or when the ferrules are extracted from the nut prior to fitting assembly (e.g., for inspection).

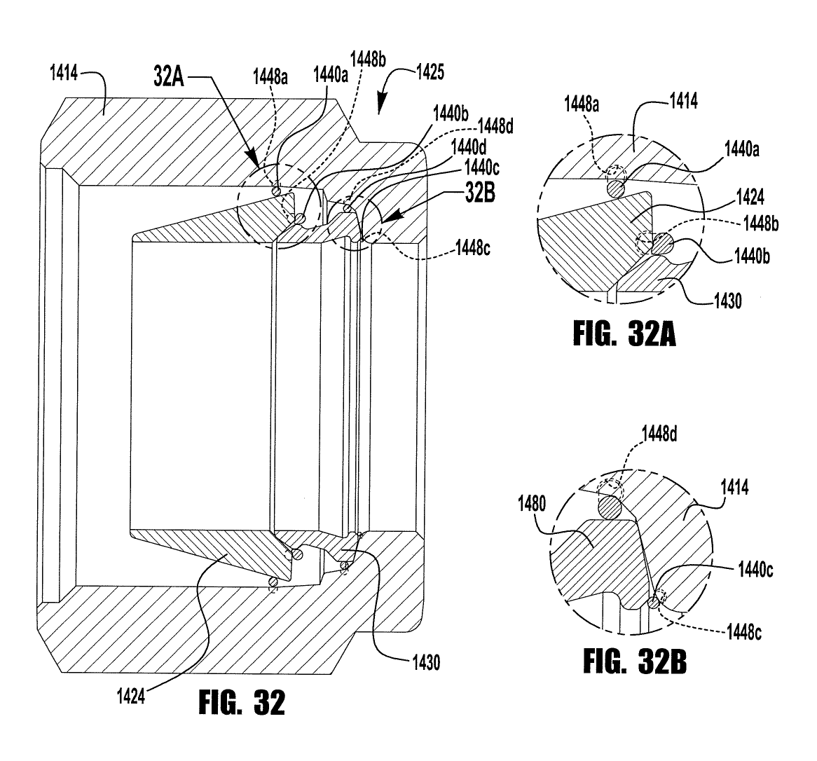

FIGS. 32, 32A, and 32B illustrate an exemplary cartridge nut and cartridged front and rear ferrule arrangement 1425 including a fitting nut 1414 and front and rear ferrules 1424, 1430. As shown, a bead, strip, or other application of releasable material 1440a, 1440b, 1440c, 1440d may be applied between one or more of (a) the front ferrule 1424 and the nut 1414, (b) the front ferrule and the rear ferrule 1430, and (c) the rear ferrule and the nut. The releasable material may be circumferentially continuous, or may be provided as one or more discrete material elements. When the nut subassembly is pulled up on a fitting body (not shown), relative rotation, axial deformation, and/or radial deformation causes one or more of the adjacent nut and ferrule surfaces to separate from the releasable material(s) 1440a, 1440b, 1440c, 1440d, thus allowing subsequent disassembly of the nut 1414 from the ferrules 1424, 1430 of the pulled up fitting. As shown, the releasable material may be at least partially retained in a pocket or recess 1448a, 1448b, 1448c, 1448d, for example, to retain the releasable material after separation of the nut from the ferrules to allow for re-cartridging of the ferrules in the nut (e.g., after inspection of the ferrules).

FIG. 33 illustrates a similar cartridge nut and cartridged front and rear ferrule arrangement 1525 including a front ferrule 1524 having a rear extension 1580 that abuts the crown portion 1536 of the rear ferrule 1530 to define a recess or pocket for receiving a releasable material 1540b for cartridging the front and rear ferrules 1524, 1530 together. Additional releasable material 1540a, 1540c, 1540d may additionally or alternatively be applied between the nut 1514 and the front ferrule 1524 and/or between the nut and the rear ferrule 1530, as shown.

According to another aspect of the present application, either or both of a ferrule outer diameter and a nut inner diameter may be provided with one or more surfaces adapted to provide for a cartridging friction fit between the ferrule and the nut. As one example, the ferrule outer diameter or the nut inner diameter may be provided with a slightly eccentric shape, such that portions of the eccentrically shaped surface frictionally engage the other of the ferrule outer diameter and the nut inner diameter to retain the ferrule in the nut. As another example, a uniform or segmented raised ring of deformable material on the ferrule outer diameter or the nut inner diameter may provide for frictional retention of the ferrule with the nut. As still another example, either or both of the ferrule outer diameter and the nut inner diameter may be provided with knurling, threads, serrations, or other such surface conditions to provide for frictional retention of the ferrule with the nut.

FIG. 33A illustrates a ferrule 1524′ having a continuous or discontinuous knurled outer diameter 1570′ and/or a nut 1514′ having a continuous or discontinuous knurled inner diameter 1550′ to provide for frictional cartridging engagement of the ferrule 1524′ with the nut 1514′. When the fitting is pulled up, axial movement of the ferrule 1524′ with respect to the nut 1514′ may cause the knurled portion(s) to be axially and radially displaced or flattened to facilitate subsequent separation of the nut 1514′ from the ferrule 1524′ when the nut is unthreaded or loosened from the fitting body. Where both the ferrule 1524′ and the nut 1514′ are provided with knurled portions, these knurled portions may grip each other for enhanced frictional retention.

FIG. 33B illustrates a ferrule 1524″ having a continuous or discontinuous axially serrated outer diameter 1570″ and/or a nut 1514″ having a continuous or discontinuous axially serrated inner diameter 1550″ to provide for frictional cartridging engagement of the ferrule 1524″ with the nut 1514″. When the fitting is pulled up, rotational movement of the nut 1514″ with respect to the ferrule 1524″ may cause the serrated portion(s) to be rotationally and radially displaced or flattened to facilitate subsequent separation of the nut 1514″ from the ferrule 1524″ when the nut is unthreaded or loosened from the fitting body. Where both the ferrule 1524″ and the nut 1514″ are provided with serrated portions, these serrated portions may grip each other for enhanced frictional retention.

According to still another aspect of the present application, one or more ferrules (or other such conduit gripping devices) may be cartridged with each other and/or with a fitting nut (or other such fitting component) using a separate retaining device that grips, holds, snaps onto, or otherwise interlocks with portions of the one or more ferrules and/or the fitting nut. In one such embodiment, the separate retaining device includes a first interlock or retaining portion that interlocks with an outer radial surface of one of the one or more ferrules, and a second interlock or retaining portion that interlocks with an interior wall of the fitting nut, such that the retaining device holds the fitting nut and the one of the one or more ferrules together as a discrete subassembly. The interlock portions of the retaining device may be formed from a material that retains its shape while allowing for elastic deformation, for example, such that the retaining device can snap into interlocking engagement with the retained fitting component(s). This elastic deformability may also allow for selective disengagement or detachment of the retained fitting component(s) from the retaining device, for example, due to forces applied during fitting pull-up, or from a user-applied axial, lateral, rotational, or pivoting force. Other types of retaining portions or retaining arrangements may be used to attach one or more fitting components to a separate retaining device, including, for example, adhesive or welded connections.

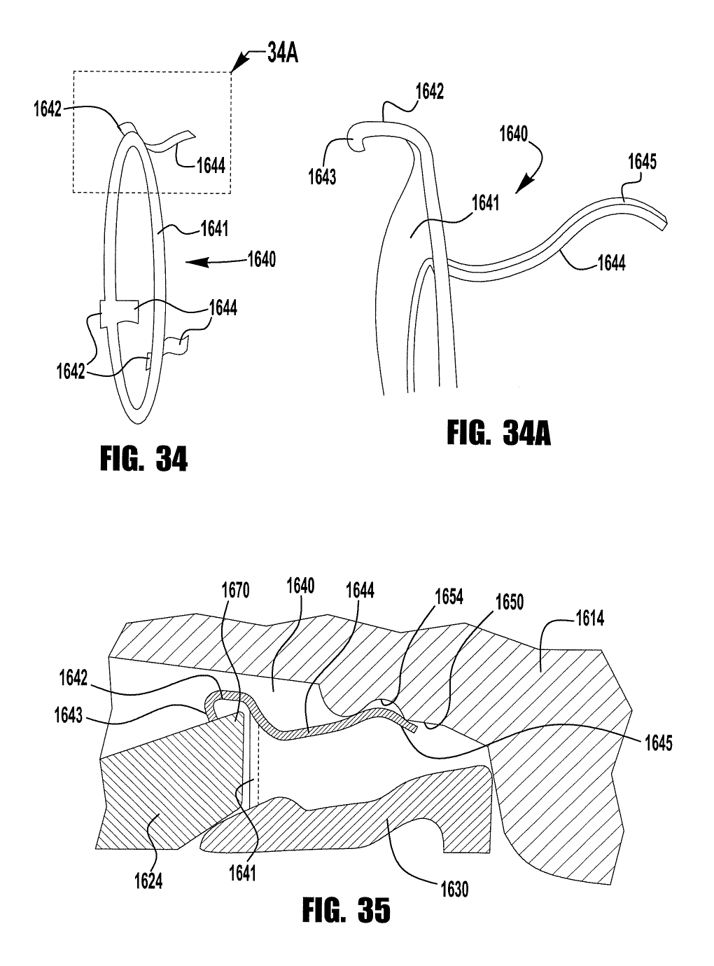

While the separate nut-ferrule retaining device may be provided in any suitable shape or structure, in an exemplary embodiment, a retaining device includes an annular frame or body portion having one or more inboard interlock tabs that interlock with an outer radial surface of the ferrule, and one or more outboard interlock tabs that interlock with an interior wall of the fitting nut. FIGS. 34 and 34A illustrate an exemplary retaining device or retaining ring 1640 having an annular body or frame portion 1641, a first plurality of inboard interlock tabs 1642 extending from a first, inboard side of the frame portion 1641, and a second plurality of outboard interlock tabs 1644 extending from a second, outboard side of the frame portion 1641. When the retaining device 1640 is assembled in a preassembly with a fitting nut 1614 and front and rear ferrules 1624, 1630, as shown in FIG. 35, radially inward extending portions 1643 of the inboard interlock tabs 1642 engage an outer radial surface 1670 of the front ferrule 1624, and radially outward extending portions 1645 of the outboard interlock tabs 1644 engage an interior wall 1650 of the fitting nut 1614, such that the retaining device holds the fitting nut 1614 and the front ferrule 1624 (along with axially captured rear ferrule 1630) together as a discrete subassembly.

In one embodiment, the interlock tabs 1642, 1644 of the retaining device 1640 are elastically deformable and contoured to provide for snap-together engagement of the retaining device 1640 with the front ferrule 1624 and the fitting nut 1614. In the illustrated embodiment of FIGS. 34 and 35, the radially inward extending portions 1643 of the inboard interlock tabs 1642 are contoured such that when the retaining device 1640 is axially pressed against the rear portion of the front ferrule 1624, the inboard interlock tabs 1642 are elastically expanded radially outward to receive the rear portion of the front ferrule therebetween, with the radially inward extending portions 1643 then snapping radially inward to axially capture the rearmost (and radially outermost) portion of the front ferrule 1624. The radially outward extending portions 1645 of the outboard interlock tabs 1644 are contoured such that when the retaining device 1640 is axially pressed into the fitting nut 1614, the outboard interlock tabs 1644 are elastically constricted radially inward to align the radially outward extending portions 1645 with an annular recessed portion 1654 of the fitting nut interior wall, with the radially outward extending portions 1645 then snapping radially outward to axially capture the interior wall recessed portion 1654.

In another exemplary embodiment, the inboard interlock tabs of the retaining device may be plastically deformed into engagement with the outer radial portion of the front ferrule, and/or the outboard interlock tabs may be plastically deformed into engagement with the interior wall of the fitting nut, for example, by crimping, staking or otherwise deforming (e.g., using a tool) the interlock tabs.

The separate retaining device may be configured to disengage from either or both of the front ferrule and the fitting nut during pull-up of the fitting on a conduit, for example, to permit disassembly of the fitting nut from the ferrules once the ferrules have been installed or swaged onto a conduit end. In an exemplary embodiment, the radially outward extending portions 1645 of the outboard interlock tabs 1644 engage a tapered interior wall surface of the fitting nut during pull-up, causing the radially outward extending portions 1645 to be plastically deformed radially inward and out of engaging alignment with the interior wall recess 1654. In other embodiments, the radially outward extending portions of the outboard interlock tabs may remain lightly engaged or in separable interlocking engagement with the interior wall recess, such that when the pulled-up fitting is disassembled, the fitting nut may be axially separated from the retaining device. Additionally or alternatively, the elastic deformability of the interlock tabs 1642, 1644 may allow a user to selectively disengage the front ferrule 1624 and/or the fitting nut 1614 from the retaining device 1640, for example, by applying one or more of an axial, lateral, rotational, or pivoting force to the retaining device and/or ferrules, for example, to inspect, treat, or replace the detached component.

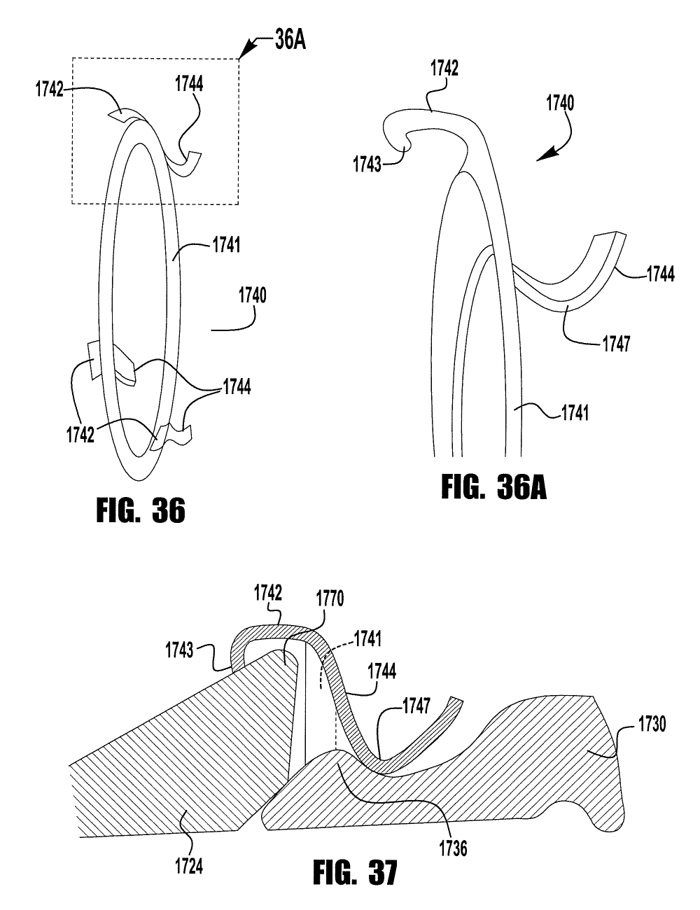

FIGS. 36 and 36A illustrate an exemplary retaining device or retaining ring 1740 having an annular body or frame portion 1741, a first plurality of inboard interlock tabs 1742 extending from a first, inboard side of the frame portion 1741, and a second plurality of outboard interlock tabs 1744 extending from a second, outboard side of the frame portion 1741. When the retaining device 1740 is assembled in a preassembly with a front ferrule 1724 and a rear ferrule 1730, as shown in FIG. 37, radially inward extending portions 1743 of the inboard interlock tabs 1742 engage an outer radial surface 1770 of the front ferrule 1724, and radially inward extending portions 1747 of the outboard interlock tabs 1744 engage an outer radial portion 1736 of the rear ferrule 1730, such that the retaining device holds the front and rear ferrules 1724, 1730 together as a discrete subassembly.

In one embodiment, the interlock tabs 1742, 1744 of the retaining device 1740 are elastically deformable and contoured to provide for snap-together engagement of the retaining device 1740 with the front ferrule 1724 and the rear ferrule 1730. In the illustrated embodiment of FIGS. 36 and 37, the radially inward extending portions 1743 of the inboard interlock tabs 1742 are contoured such that when the retaining device 1740 is axially pressed against the rear portion of the front ferrule 1724, the inboard interlock tabs 1742 are elastically expanded radially outward to receive the rear portion of the front ferrule therebetween, with the radially inward extending portions 1743 then snapping radially inward to axially capture the rearmost (and radially outermost) portion of the front ferrule 1724. The radially inward extending portions 1747 of the outboard interlock tabs 1744 are contoured such that when the retaining device 1740 is axially pressed against the front portion 1736 of the rear ferrule 1730, the outboard interlock tabs 1744 are elastically expanded radially outward to receive the front portion of rear ferrule therebetween, with the radially inward extending portions 1747 then snapping radially inward to axially capture the front (and radially enlarged) portion of the rear ferrule 1730.

In another exemplary embodiment, the inboard interlock tabs of the retaining device may be plastically deformed into engagement with the outer radial rear portion of the front ferrule, and/or the outboard interlock tabs may be plastically deformed into engagement with the outer radial front portion of the rear ferrule, for example, by crimping, staking or otherwise deforming (e.g., using a tool) the interlock tabs.

The separate retaining device may be configured to disengage from either or both of the front ferrule and the rear ferrule during pull-up of the fitting on a conduit, for example, to permit or maintain a desired two ferrule function (“TFF”) of the ferrules during pull-up, as described, for example, in U.S. Pat. No. 9,267,627, the entire disclosure of which is incorporated herein by reference. In an exemplary embodiment, the radially inward compression of the front portion of the rear ferrule 1730 during pull-up may cause the front portion of the rear ferrule 1730 to be plastically deformed radially inward and out of engaging alignment with the radially inward extending portions 1747 of the outboard interlock tabs 1744. In other embodiments, the retaining device may loosely capture either or both of the front ferrule rear portion and the rear ferrule front portion, thereby permitting desired relative movement of the front and rear ferrules during pull-up. Additionally or alternatively, the elastic deformability of the interlock tabs 1742, 1744 may allow a user to selectively disengage the front ferrule 1724 and/or the rear ferrule from the retaining device 1740, for example, by applying one or more of an axial, lateral, rotational, or pivoting force to the retaining device and/or ferrules, for example, to inspect, treat, or replace the detached component.

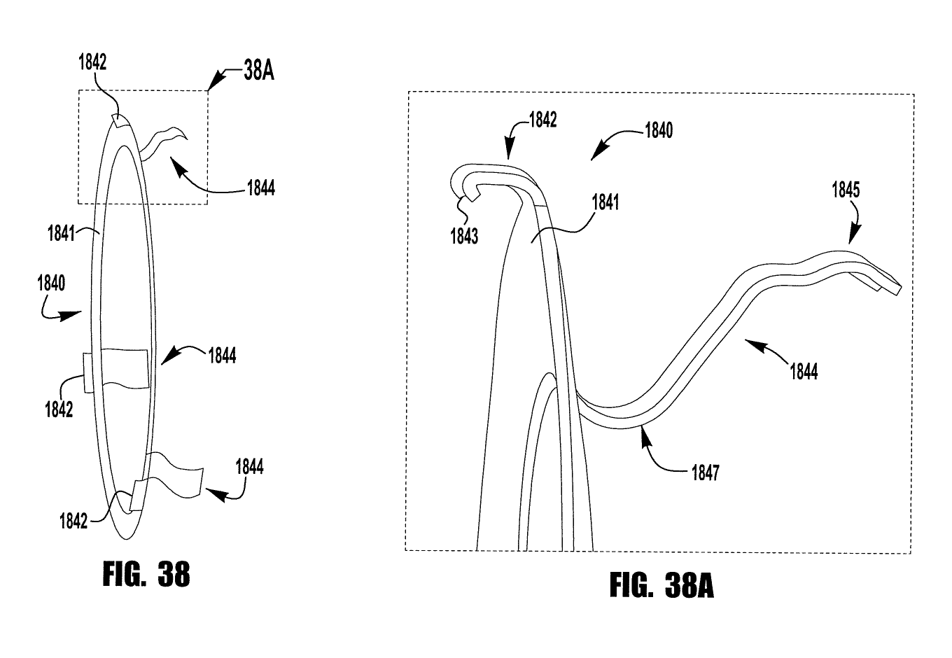

In another embodiment, a retaining device may be configured to initially retain a front ferrule and rear ferrule together as a ferrule preassembly, and to subsequently retain the front and rear ferrules with a fitting nut when the ferrule preassembly is installed in the fitting nut. FIGS. 38 and 38A illustrate an exemplary retaining device or retaining ring 1840 having an annular body or frame portion 1841, a first plurality of inboard interlock tabs 1842 extending from a first, inboard side of the frame portion 1841, and a second plurality of outboard interlock tabs 1844 extending from a second, outboard side of the frame portion 1841. When the retaining device 1840 is assembled in a preassembly with a front ferrule 1824 and a rear ferrule 1830, as shown in FIG. 41, radially inward extending portions 1843 of the inboard interlock tabs 1842 engage an outer radial surface 1870 of the front ferrule 1824, and radially inward extending portions 1847 of the outboard interlock tabs 1844 engage an outer radial surface 1836 of the rear ferrule 1830, such that the retaining device holds the front and rear ferrules 1824, 1830 together as a discrete subassembly.

To subsequently retain the front and rear ferrules 1824, 1830 preassembly with a fitting nut 1814 when the ferrule preassembly is installed in the fitting nut, the retaining device includes radially outward extending portions 1845 on an outboard side of the frame portion 1841, for engagement with an interior wall 1850 of the fitting nut 1814. While these radially outward extending portions 1845 may be disposed on separate tabs or other such portions of the retaining device 1840, in the illustrated embodiment, the radially outward extending portions 1847 are defined by the same outboard interlock tabs 1844 that define the radial inward extending portion 1847 that engage the front portion of the rear ferrule 1830. When the retaining device 1840 is assembled in a preassembly with a fitting nut 1814 and front and rear ferrules 1824, 1830, as shown in FIG. 43, the radially outward extending portions 1845 of the outboard interlock tabs 1844 engage an interior wall 1850 of the fitting nut 1814, such that the retaining device holds the fitting nut 1814 and the front and rear ferrules 1824, 1830 together as a discrete subassembly.

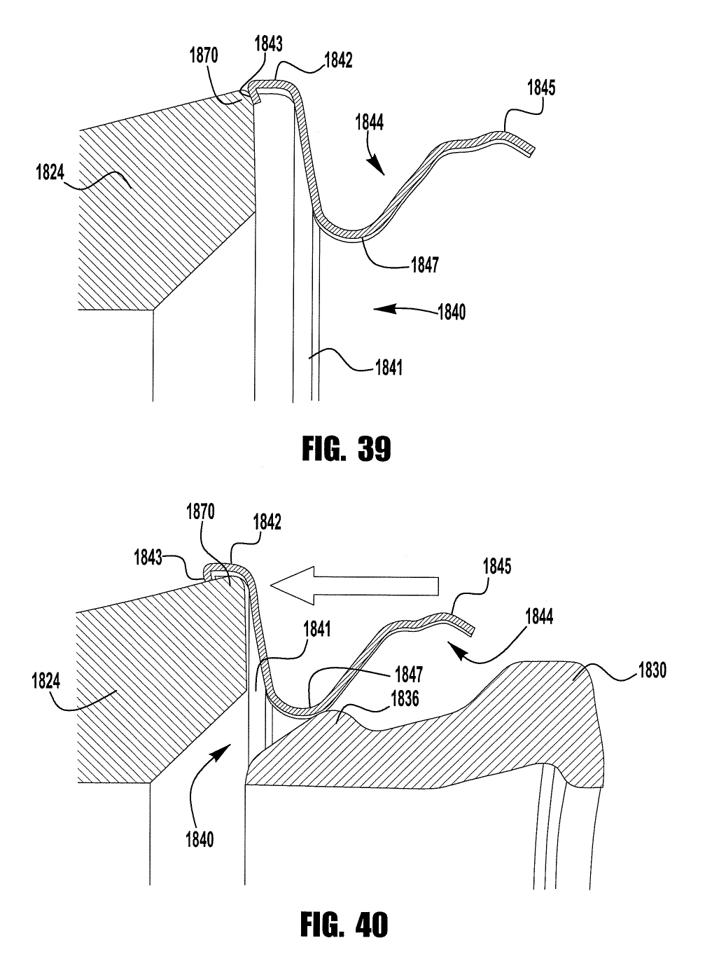

In one embodiment, the inboard and outboard interlock tabs 1842, 1844 of the retaining device 1840 are elastically deformable and contoured to provide for initial snap-together engagement of the retaining device 1840 with the front ferrule 1824 and the rear ferrule 1830, and the outboard interlock tabs 1844 are elastically deformable to provide for subsequent snap-together engagement of the retaining device 1840 with the fitting nut when the ferrule preassembly is installed in the fitting nut. In the illustrated embodiment of FIGS. 38-43, the radially inward extending portions 1843 of the inboard interlock tabs 1842 are contoured such that when the retaining device 1840 is axially pressed against the rear portion 1870 of the front ferrule 1824 (FIG. 39), the inboard interlock tabs 1842 are elastically expanded radially outward to receive the rear portion of the front ferrule therebetween, with the radially inward extending portions 1843 then snapping radially inward to axially capture the rearmost (and radially outermost) portion 1870 of the front ferrule 1824 (FIG. 40). The radially inward extending portions 1847 of the outboard interlock tabs 1844 are contoured such that when the retaining device 1840 is axially pressed against the front portion 1836 of the rear ferrule 1830 (FIG. 40), the outboard interlock tabs 1844 are elastically expanded radially outward to receive the front portion of rear ferrule therebetween, with the radially inward extending portions 1847 then snapping radially inward to axially capture the front (and radially enlarged) portion of the rear ferrule 1830, resulting in a cartridged ferrule preassembly (FIG. 41).

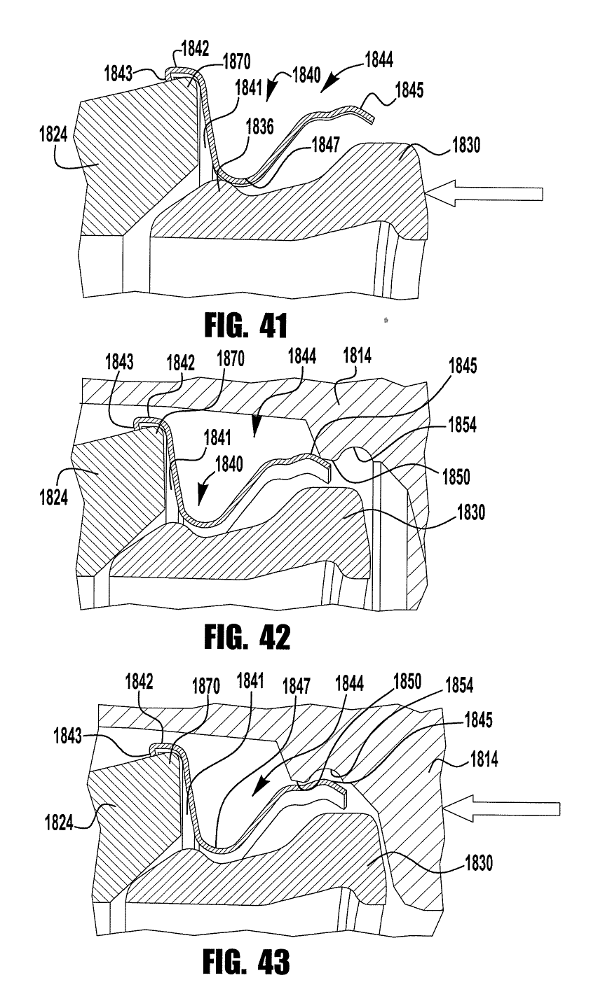

The radially outward extending portions 1845 of the outboard interlock tabs 1844 are contoured such that when the cartridged ferrules 1824, 1830 and retaining device 1840 are axially pressed into the fitting nut 1814 (FIG. 42), the radially outward extending portions 1845 of the outboard interlock tabs 1844 are elastically constricted radially inward to align the radially outward extending portions 1845 with an annular recessed portion 1854 of the fitting nut interior wall, with the radially outward extending portions 8645 then snapping radially outward to axially capture the interior wall recessed portion 1854 (FIG. 43).

The separate retaining device may be configured to disengage from one or more of the front ferrule, the rear ferrule, and the fitting nut during pull-up of the fitting on a conduit, for example, to permit disassembly of the fitting nut from the ferrules once the ferrules have been installed or swaged onto a conduit end, or to permit or maintain a desired two ferrule function. In an exemplary embodiment, the radially outward extending portions 1845 of the outboard interlock tabs 1844 may engage a tapered interior wall surface of the fitting nut during pull-up, causing the radially outward extending portions 1845 to be plastically deformed radially inward and out of engaging alignment with the interior wall recess 1854. In other embodiments, the radially outward extending portions of the outboard interlock tabs may remain lightly engaged or in separable interlocking engagement with the interior wall recess, such that when the pulled-up fitting is disassembled, the fitting nut may be axially separated from the retaining device. Additionally or alternatively, the radially inward compression of the front portion of the rear ferrule 1830 during pull-up may cause the front portion of the rear ferrule 1830 to be plastically deformed radially inward and out of engaging alignment with the radially inward extending portions 1847 of the outboard interlock tabs 1844. In still other embodiments, the retaining device may loosely capture either or both of the front ferrule rear portion and the rear ferrule front portion, thereby permitting desired relative movement of the front and rear ferrules during pull-up. Additionally or alternatively, the elastic deformability of the interlock tabs 1842, 1844 may allow a user to selectively disengage one or more of the front ferrule 1824, the rear ferrule 1830, and the fitting nut 1814 from the retaining device 1840, for example, by applying one or more of an axial, lateral, rotational, or pivoting force to the retaining device and/or ferrules, for example, to inspect, treat, or replace the detached component.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

1. A preassembly for a conduit fitting comprising:
a first conduit gripping device comprising a rear portion defining a first outer radial surface;
a second conduit gripping device comprising a front portion defining a second outer radial surface; and
a retaining device having a first interlock portion that interlocks with the first outer radial surface, and a second interlock portion that interlocks with the second outer radial surface, such that the retaining device holds said first conduit gripping device and said second conduit gripping device together as a discrete subassembly.

2. The preassembly of claim 1, wherein at least one of the first and second conduit gripping devices is separable from the retaining device by applying an axial force to the at least one of the first and second conduit gripping devices.

3. The preassembly of claim 1, wherein at least one of the first and second conduit gripping devices is separable from the retaining device by applying one or more of an axial, lateral, rotational or pivoting force to the at least one of the first and second conduit gripping devices.

4. The preassembly of claim 1, wherein the retaining device comprises an annular frame, at least one front tab extending forward from the annular frame to define the first interlock portion, and at least one rear tab extending rearward from the annular frame to define the second interlock portion.

5. The preassembly of claim 4, wherein the at least one front tab extends from an outer diameter of the annular frame.

6. The preassembly of claim 4, wherein the at least one rear tab extends from an inner diameter of the annular frame.

7-8. (canceled)

9. The preassembly of claim 4, wherein the at least one front tab comprises a radially inward extending hook portion configured to grip the first outer radial surface.

10. The preassembly of claim 4, wherein the at least one rear tab comprises a radially inward and axially rearward extending bent portion configured to grip the second outer radial surface.

11. The preassembly of claim 10, wherein the at least one rear tab comprises a radially outward extending end portion.

12. (canceled)

13. The preassembly of claim 1, wherein the rear portion of the first conduit gripping device comprises an inner camming surface, and the front portion of the second conduit gripping device comprises a forward facing tapered contact surface that contacts said camming surface.

14. The preassembly of claim 13, wherein the second outer radial surface comprises a rearward facing contour surface axially rearward of the contact surface.

15. The preassembly of claim 14, wherein the front portion of the second conduit gripping device comprises a crown portion having a front surface defining the contact surface and a rear surface defining the contour surface.

16. A preassembly for a conduit fitting comprising:
an annular fitting component having an interior wall extending along a central axis from an inboard end to an outboard end;
a conduit gripping device disposed in the annular fitting component and comprising an outer radial surface at a back portion thereof; and
a retaining device having an inboard first interlock portion that interlocks with the outer radial surface of the conduit gripping device, and an outboard second interlock portion axially spaced apart from the first interlock portion, the second interlock portion interlocking with the interior wall of the annular fitting component, such that the retaining device holds said annular fitting component and said conduit gripping device together as a discrete subassembly.

17. The preassembly of claim 16, wherein at least one of the annular fitting component and the conduit gripping device is separable from the retaining device by applying an axial force to the at least one of the annular fitting component and the conduit gripping device.

18. The preassembly of claim 16, wherein at least one of the annular fitting component and the conduit gripping device is separable from the retaining device by applying one or more of an axial, lateral, rotational or pivoting force to the at least one of the annular fitting component and the conduit gripping device.

19. The preassembly of claim 16, wherein the retaining device comprises an annular frame, at least one inboard tab extending forward from the annular frame to define the first interlock portion, and at least one outboard tab extending rearward from the annular frame to define the second interlock portion.

20. The preassembly of claim 19, wherein the at least one inboard tab extends from an outer diameter of the annular frame.

21. The preassembly of claim 19, wherein the at least one outboard tab extends from an inner diameter of the annular frame.

22-23. (canceled)

24. The preassembly of claim 19, wherein the at least one inboard tab comprises a radially inward extending hook portion configured to grip the outer radial surface of the conduit gripping device.

25. The preassembly of claim 19, wherein the at least one outboard tab comprises a radially outward and axially rearward extending bent portion configured to grip the interior wall of the annular fitting component.

26. (canceled)

27. The preassembly of claim 16, wherein the interior wall of the annular fitting component comprises an annular recess engaging the second interlock portion of the retaining device.

28. The preassembly of claim 16, wherein the conduit gripping device is a first conduit gripping device, the preassembly further comprising a second conduit gripping device disposed in the annular fitting component between the first conduit gripping device and a drive surface of the annular fitting component.

29. The preassembly of claim 28, wherein the retaining device further comprises a third interlock portion that interlocks with an outer radial surface on a front portion of the second conduit gripping device.

30-36. (canceled)

37. A method of pre-installing a conduit gripping device in an annular fitting component, the method comprising:
providing an annular fitting component having an interior wall extending along a central axis from an inboard end to an outboard end;
providing a preassembly including a conduit gripping device and a retaining device having an inboard first interlock portion that interlocks with an outer radial surface on an outboard portion of the conduit gripping device; and
inserting the preassembly into the inboard end of the annular fitting component to interlock an outboard second interlock portion of the retaining device with the interior wall of the annular fitting component, such that the retaining device holds said annular fitting component and said conduit gripping device together as a discrete subassembly.

38. The method of claim 37, wherein the conduit gripping device comprises a first conduit gripping device, the preassembly further comprising a second conduit gripping device having a front portion defining an outer radial surface that interlocks with a third interlock portion of the retaining device.

39.-100. (canceled)
